(19) United States
(12) Patent Application Publication
(10) Pub. No.: US 2025/0078157 A1
(43) Pub. Date: Mar. 6, 2025

(54) ASSET-BACKED TOKENIZATION SYSTEM FOR PROGRESSIVE ASSET OWNERSHIP

(71) Applicant: EL-DAR AL-KHASSEH LTITWER AL-OMRANI Ltd., Jeddah (SA)

(72) Inventors: Essam Fakieh, Jeddah (SA); Ahmed A. Fadol, Washington, DC (US)

(21) Appl. No.: 18/809,158

(22) Filed: Aug. 19, 2024

Related U.S. Application Data
(60) Provisional application No. 63/535,752, filed on Aug. 31, 2023.

(51) Int. Cl. G06Q 40/06; G06Q 20/36

(52) U.S. Cl. CPC G06Q 40/06; G06Q 20/36; G06Q 2220/00

(57) ABSTRACT

Described is a system for gradual change of asset ownership using tokenization by receiving a digitized asset rights document for a real world asset from an asset holder, generating digital tokens corresponding to the value of the real world asset based on the value and a value for each digital token, each digital token representing a fractional ownership interest in the real world asset, receiving an asset transaction from the asset utilizer utilizing the real world asset, transferring a number of digital tokens corresponding to a portion of the transaction from the digital wallet of the asset holder to a digital wallet of the asset utilizer, determining that a quantity of digital tokens within the digital wallet of the asset utilizer equals or exceeds the value of the real world asset, and transferring the digitized asset rights document to the asset utilizer, indicating full ownership by the asset utilizer.

### TECHNICAL FIELD

This patent application claims the benefit of U.S. Provisional Patent Application No. 63/535,752, filed Aug. 31, 2023, entitled “Asset-backed Tokenization System for Progressive Asset Ownership”, which is incorporated by reference herein in its entirety.

### TECHNICAL FIELD

The present disclosure relates generally to a tokenization system, and more specifically to an asset-backed tokenization system for progressive asset ownership.

### BACKGROUND

Traditional home ownership often involves acquiring a mortgage from a financial institution like a bank or a mortgage lender. In this setup, an aspiring homeowner, upon finding a suitable property, applies for a mortgage loan. The lender evaluates the applicant's creditworthiness based on their financial history, current income, and debt levels, among other factors. If the application is approved, the lender provides the funds necessary to purchase the home, and the homebuyer agrees to repay the loan over a predefined period, typically in monthly installments over 15 to 30 years. The property serves as collateral, which means that if the borrower fails to make the required payments, the lender has the right to take possession of the home (foreclosure) and sell it to recover their funds. Over time, as the homebuyer makes their mortgage payments, they gradually build equity in the home, which represents their financial stake or ownership interest in the property. When the loan is fully repaid, the lender releases the lien to the deed, indicating full ownership to the home buyer.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 illustrates an architecture for tokenizing of a real estate asset, according to some examples.

FIG. 2 illustrates an architecture comparing conventional mortgage and rental systems with the tokenization system regarding ownership of the property over time, according to some examples.

FIG. 3 illustrates an architectural diagram between the tokenization system, asset owners, and individuals, according to some examples.

FIG. 4 illustrates an example method for progressive ownership through asset utilization using the tokenization system, according to some examples.

FIG. 5 illustrates an architectural diagram of progressive ownership, according to some examples.

FIG. 6 illustrates an example architecture for the right of use and ownership of an asset, according to some examples.

FIG. 7 illustrates an example of a home valued at $1,000,000 gradually changing ownership to an asset utilizer, according to some examples.

FIG. 8 is a diagrammatic representation of a machine in the form of a computer system within which a set of instructions may be executed to cause the machine to perform any one or more of the methodologies discussed herein, according to some examples.

FIG. 9 is a block diagram showing a software architecture within which examples may be implemented.

FIG. 10 illustrates a machine-learning pipeline, according to some examples.

FIG. 11 illustrates training and use of a machine-learning program, according to some examples.

FIG. 12 illustrates tokenization of an asset as a whole, according to some examples.

FIG. 13 illustrates tokenization of an asset that is divisible into parts, according to some examples.

FIG. 14 illustrates tokenizing ownership and/or usage across time, according to some examples.

FIG. 15 illustrate tokenizing ownership and/or usage across time and parts, according to some examples.

FIG. 16 illustrates tokenization for use allocations, according to some examples.

FIG. 17 illustrates token generation based on location, according to some examples.

FIG. 18 illustrates token generation for copies of goods, according to some examples.

### DETAILED DESCRIPTION

Traditional systems come with several limitations and challenges. Traditional mortgage systems are rigid and cannot easily adjust to the changing financial circumstances of homeowners. If homeowners encounter financial difficulties, they are at risk of defaulting on their mortgage payments, leading to foreclosure and loss of their investment. Moreover, there is no existing technology in traditional systems that enables renters to own equity for a future home. The homeowners need to pay a large down payment, generally about 20%, and take a loan for the remainder amount, requiring a lot of upfront cost and prolonged risk for the term of the loan.

Moreover, real estate, in its traditional form, is an illiquid asset. This means it can take a considerable amount of time to buy a property or to sell a property to convert it into cash. This lack of liquidity can be a significant issue for homeowners who need to access the value of their property quickly.

Traditional real estate transactions involve many intermediary systems, which can lead to delays, inefficiencies, and high transaction costs. Real estate transactions require a significant amount of paperwork, from the initial purchase agreement to the final closing documents. This can be a slow and inefficient process, prone to human error.

Even after all terms are agreed upon and the mortgage is approved, the process of transferring funds, paying all related fees, and finalizing the transaction (known as “closing”) can be complex and time-consuming. It requires a high level of coordination among multiple parties, and any missteps can result in significant delays. Moreover, costs throughout the process can include realtor fees, closing costs, notary fees, and other administrative charges, which can make the process of buying or selling a home expensive.

Traditional real estate transactions can be opaque and complex, which can lead to potential fraudulent activities. Issues such as double spending, selling disputed properties, or fraudulent alterations to property deeds are risks in the traditional system, creating uncertainty and mistrust.

Examples of the example tokenization system as described herein mitigate and/or eliminate the pitfalls of traditional systems as described above. The example tokenization system presented here introduces an innovative way of real estate ownership through tokenization.

The tokenization system divides a physical asset, such as a property, into digital tokens that represent ownership of a fraction of the underlying asset. This approach to property ownership uses the principles of tokenization (such as a distributed ledger or blockchain technology) to divide the asset's value into equally valued tokens, and a number of a certain number of tokens equal the value of the asset.

The tokenization system evaluates the asset owner's property and receives the deed from the asset owner. The tokenization system then generates (or mints) a specific number of tokens equivalent to the property's value. These tokens represent a digital version of property ownership and can be bought, sold, or traded, much like traditional property rights but with the added technical advantages of digital assets, as will be further described herein.

The tokenization system introduces a new technological paradigm of renting and ownership. A tenant can rent the home, and instead of merely paying rent, the tenant also has an option to gradually purchase tokens from the asset owner over a period of time. Over time, the tenant could potentially acquire all the necessary tokens, and in doing so, effectively become the homeowner. At this point, the tokenization system transfers ownership of the property to the tenant (e.g., by transferring over the deed, recording ownership of the property to a regulatory authority, etc.). In some cases, the corresponding tokens for the property are purged from the system.

The tokenization system also accounts for different scenarios. If a tenant decides not to renew his or her lease before owning all tokens, the tokenization system allows the asset owner to repurchase the tokens. In some cases, the tenant can resell their owned tokens on the open market, converting their token equity back into a liquid asset. Alternatively, the tokenization system enables transfer of tokens to another property by releasing the deed to the first property owner, and begins the technological steps for tokenization for the next property. For example, the tokens purchased by the tenant during the term of their lease can be applied as equity to the second property, such that the new tenant would only have to obtain the remaining amount of equity to own the new home.

In essence, the tenant is able to carry fungible equity via these tokens. They can manage their investment fluidly, leveraging the benefits of tokenization to bring flexibility and accessibility to real estate ownership. This system revolutionizes the housing market by introducing a practical, technology-centric solution to many of the issues plaguing the traditional path to homeownership.

The tokenization system addresses the limitations and challenges in traditional systems using the features described herein. By allowing tenants to gradually earn equity in a property through the acquisition of tokens, the tokenization system introduces a more flexible model of homeownership. The risk of foreclosure is mitigated, as tenants provide liquidity by reselling their tokens in case of financial difficulties.

The tokenization system eliminates the need for a large upfront down payment, as is required in traditional mortgage systems. Tenants gradually accrue ownership of the property through purchases of tokens, making the path to homeownership less financially burdensome.

The issue of illiquidity associated with traditional real estate is resolved through the tokenization of property. Tenants can quickly sell their tokens on the open market if they need to access the value of their property quickly.

The tokenization system eliminates the need for multiple intermediaries involved in traditional real estate transactions. This reduces delays and inefficiencies, and lowers transaction costs as token transactions are less expensive than traditional real estate transactions.

By leveraging tokenization (such as distributed ledger and blockchain technology), the tokenization system ensures transparency and reduces the potential for fraudulent activities. All token transactions are immutable and publicly visible on the blockchain, thereby reducing the risk of fraudulent alterations to property deeds.

In essence, by enabling tenants to gradually earn equity in a property, making real estate a more liquid asset, increasing efficiency and lowering transaction costs, and ensuring transparency, the tokenization system presents a novel and superior approach to property ownership, bringing increased transparency, flexibility, and efficiency to the real estate market using the technology of tokenization.

When the effects in this disclosure are considered in aggregate, one or more of the methodologies described herein may improve known systems, providing additional functionality (such as, but not limited to, the functionality mentioned above), making them easier, faster, or more intuitive to operate, and/or obviating a need for certain efforts or resources that otherwise would be involved in the tokenization process. Computing resources used by one or more machines, databases, or networks may thus be more efficiently utilized or even reduced.

### Tokenization of Asset

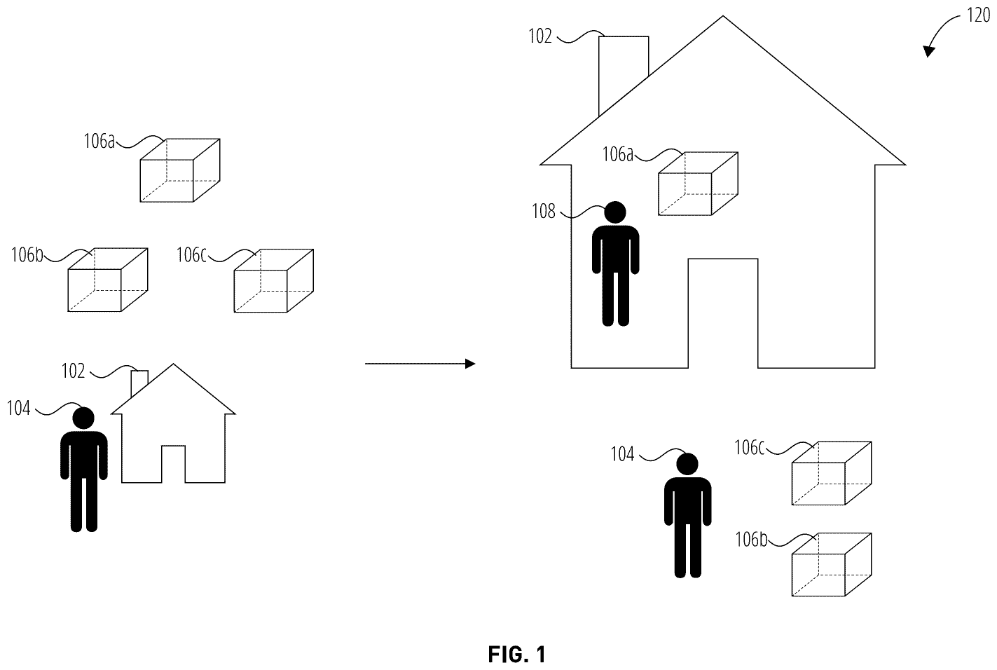

FIG. 1 illustrates an architecture 120 for tokenizing of a real estate asset, according to some examples. The process of tokenizing a home or an asset by the tokenization system can be described into several steps.

One step is for the tokenization system to evaluate the property to determine its current market value. In some cases, the tokenization system employs technological methods for estimating the value of a property. In some cases, the tokenization system compares the property to similar properties in the same area that have been sold recently by retrieving data from third party real estate databases.

In some cases, the tokenization system applies a regression analysis that can determine how different variables (like location, size, age, number of rooms, and nearby amenities) impact the property's value. The algorithm is trained on a vast dataset of property sales to learn the weight of each variable.

In some cases, the tokenization system applies Geographic Information System (GIS) data, which includes geographical and topological data about a property and its surroundings. The tokenization system applies this data to assess the value based on physical features like proximity to water bodies, hills, parks, and more.

In some cases, the tokenization system applies one or more artificial neural networks to predict property values. The neural network is trained on a large dataset and can handle complex, non-linear relationships between variables (such as data related to the property and other similar assets), making the estimate more accurate.

Although artificial intelligence, neural networks, and machine learning models are disclosed as performing certain features, it is appreciated that a machine learning model can be trained and applied by the tokenization system to perform any or all of the features of the tokenization system as described herein. For example, a first machine learning model facilitates decisioning by the tokenization system between modules and other machine learning models, whereas a second machine learning model generates a prediction of property values.

Systems and methods described herein include training a machine learning network, such as training to generate smart contracts, predict property values, mint tokens, facilitate transactions to various individuals and wallets, perform features on deeds and ownership, and/or the like. The machine learning network can be trained to perform one or more of the features for the tokenization system as described herein.

The machine learning algorithm can be trained using historical information. For example, the machine learning model is trained to generate smart contracts by applying historical real estate transactions for use cases on the tokenization system, resulting in self-executing smart contracts which are deployed on the blockchain (e.g., sent to the blockchain network and stored on the distributed ledger).

Training of models, such as artificial intelligence models, is necessarily rooted in computer technology, and improves modeling technology by using training data to train such models and thereafter applying the models to new inputs to make inferences on the new inputs. Here, the new inputs can be information relating to a new homeowner requesting tokenization of the home to rent and slowly sell the home to a new tenant. The trained machine learning model performs the various features of enabling the homeowner to tokenize the home and enable the new tenant to progressively own the home.

Such training involves complex processing that typically requires a lot of processor computing and extended periods of time with large training data sets, which are typically performed by massive server systems. Training of models can require logistic regression and/or forward/backward propagating of training data that can include input data and expected output values that are used to adjust parameters of the models.

Such training is the framework of machine learning algorithms that enable the models to be applied to new and unseen data (such as new tenant or asset owner data) and make predictions that the model was trained for based on the weights or scores that were adjusted during training. Such training of the machine learning models described herein reduces false positives and increases the performance.

Once the property value is established, the homeowner submits a digital version of the deed to the tokenization system. This deed serves as a legal proof of ownership and will be held by the tokenization system for the duration of the rental agreement.

Using the property's evaluated value and a particular value for each token (whether a predefined value or current market value), the tokenization system determines a number of tokens to be minted. For example, if a home 102 of FIG. 1 is valued at $300,000 and each token is worth $100,000, the system mints 3 tokens 106a, 106b, 106c (collectively referred to herein as tokens 106). These tokens are digital representations of ownership in the property.

The tokenization system mints new tokens on the blockchain or distributed ledger by creating new digital tokens or coins. First, the tokenization system generates a smart contract and is deployed to the blockchain. This contract serves as the blueprint for the new tokens and contains rules about how the tokens can be transferred, how many will exist, and other necessary specifications.

Once the smart contract is live, the blockchain invokes the smart contract to mint new tokens. When the mint function is called, a specified number of tokens are created and assigned to the specified owner's address. In this case, an asset owner 104 is assigned as the owner of the tokens 106 representing full ownership of the home 102. As the minted tokens are then awarded to the homeowner, the tokenization system effectively converts the real-world asset into a digital form of ownership that can be divided, sold, or traded.

Although the examples described herein explain blockchain technology, digital ledger technology, tokens, and/or smart contracts to apply to particular examples, it is appreciated that the features of the tokenization system can be applied to other blockchains, tokens, and/or smart contracts. For example, blockchain technology can be applied to predict property values, and mint tokens, whereas smart contracts can be applied to facilitate a transaction (such as a payment) to various individuals and wallets, perform features on deeds and ownership, and/or the like.

The advent of blockchain technology, tokenization, and/or smart contracts improve trusts in the tokenization system using various features rooted in technology. Blockchain technology ensures that once a transaction is recorded on the blockchain, it can't be changed. In the context of the tokenization system, once the owner receives tokens corresponding to their property's value, that transaction is recorded permanently. The same goes for each token that a tenant purchases. This creates a clear, immutable record of who owns the asset, making the system much more trustworthy.

Moreover, every transaction on the blockchain is visible to all network participants. This means that the process of tokenization, as well as each subsequent token purchase, is completely transparent. No one can secretly change the number of tokens or alter the value of the asset, because such a change would be visible to everyone on the network.

The decentralized nature of blockchain also contributes to its trustworthiness. Rather than relying on a single entity (like a bank or government) to verify transactions, blockchain uses a network of nodes (computers). Each node has a copy of the blockchain, and transactions are verified through a consensus process. In essence, multiple parties agree on the validity of transactions, making it virtually impossible for fraudulent activity to occur.

The tokenization system can use smart contracts to facilitate one or more processes of the tokenization system. The tokenization system writes (or a machine learning model automatically generates) smart contracts to automatically perform features of the tokenization system as described herein, such as transferring tokens from the tenant to the owner upon receipt of a transaction (such as a payment), and transferring ownership of the asset once all tokens have been purchased. Smart contracts execute automatically when certain conditions are met, and because they're also stored on the blockchain, they're transparent, immutable, and verifiable.

Tokenization of asset ownership, such as in the case of real estate, provides enhanced security and privacy in several ways. With the blockchain or similar decentralized technology that underlies tokenization, there's no central authority holding all the data. This makes it harder for cybercriminals to exploit a single point of failure.

Moreover, once a transaction is recorded and confirmed on the blockchain, it can't be altered or tampered with. This prevents any fraudulent changes to the ownership records. Every token can be tracked from its inception, offering a clear and indisputable lineage of ownership.

Blockchain uses strong cryptographic algorithms to ensure the data in the blockchain can only be read by those involved in the transaction. This means personal and financial data can be securely stored and transferred. The tokenization system applies cryptography to tokenize real estate or any asset on a blockchain. In some cases, the tokenization system applies a public-key (asymmetric) cryptography using pairs of keys: public keys (which may be known to others), and private keys (which are known only to the owner).

The generation of such keys depends on cryptographic algorithms based on mathematical problems to produce one-way functions. The owner of the private key can use the key to sign transactions or data, and anyone with the public key can verify the signature. In the context of blockchain tokenization, the ownership of tokens (and therefore the real estate) can be proven by the possession of the private key.

The tokenization system includes a hash function, which given an input, produces a fixed size string of bytes. Every transaction in a blockchain can be hashed and the hash value is stored in the block. Any change in the transaction data would change the hash, which can easily be checked. These hash functions ensure data integrity.

When a token owner wants to transfer their tokens (representing ownership or equity in a real estate property), the token owner can create a transaction and sign it with their private key. This digital signature proves that the transaction was created by the actual owner and was not tampered with. Anyone can verify the signature with the corresponding public key, but they cannot forge the signature without the private key.

In some cases, the tokenization system encrypts sensitive data using the public key which can only be decrypted using the corresponding private key. This means even if someone else gets hold of this encrypted data, they can't read or understand it without the private key.

These cryptographic features and algorithms of the tokenizing system underpin the security, trust, and immutability aspects of the asset-backed tokens that represent equity in the asset. Such use of keys improves data security by restricting unauthorized use, view, and/or recordation of data onto the tokenization system.

These keys are used to authenticate users to data (such as ownership) or transactions (such as a request to tokenize a real world asset) which increases security, prevents unauthorized access by third parties, and enables users of the tokenization system to apply features in an easily implemented way. Moreover, such encryption features are necessarily rooted in computer technology.

With tokenization, personal details can be kept private while still proving ownership. Rather than sharing all of your personal information, a token representing ownership can be transferred while your personal data stays secured.

The tokenization system applies smart contracts which are self-executing contracts embedded with the terms of the agreement directly written into code and/or onto the distributed ledger. The smart contracts permit trusted transactions and agreements to be carried out among disparate parties without the need for a central authority, legal system, or external enforcement mechanism.

Traditional transactions typically involve intermediaries, such as banks or transaction processors, that have access to all transaction data. With blockchain technology, transactions are made directly between parties, which means that sensitive data, such as transaction information, isn't exposed to third-party companies. This reduces the risk of sensitive data being intercepted or misused.

In summary, through the use of blockchain and tokenization, you can create a secure, transparent system for real estate ownership and transactions that minimizes the risk of fraud, protects privacy, and enhances the security of sensitive data.

A tenant 108 rents the property and, in addition to paying rent, begins to purchase tokens from the homeowner. These transactions can be made separately or as part of the rent payment. Over the duration of the lease, the tenant can acquire one or more tokens, such as token 106a, thereby gaining a portion of ownership in the property.

As the tenant begins to acquire tokens, the proceeds or dividends from the property are divided among the token holders based on their percentage of ownership. In the given example, if the tenant 108 has acquired one token 106a, the tenant would receive ⅓ of the proceeds, while the homeowner would receive ⅔. The proceeds to the tenant can be less than ⅓ of the rent as the proceeds can be determined by subtracting expenses from the rent (such as insurance, property tax, property management). The homeowner could get more than ⅔ if the homeowner is the one performing property management.

This technical method of tokenization enables gradual transfer of ownership from the homeowner to the tenant and provides both parties with more flexibility and liquidity than traditional systems. It also allows for a more seamless and efficient real estate transaction process, reducing the need for intermediaries and reducing costs.

The tokenization system uses a combined order of specific procedures that tokenizes real world properties that represent ownership, and these tokens are used in a variety of different and novel ways as described herein. Not only do some examples and features of the tokenization system eliminate the need for intermediaries that are typical in the home purchasing process, the process of the tokenization system is also different than the process for traditional systems.

The tokenization does not simply automate traditional systems and concepts. By leveraging tokenization technology, the tokenization system enables efficiencies and improvements to the real estate world, such as by leasing of ownership and partial ownership, progressive ownership as a tenant using the property, deed recordation and ownership facilitation, other features of the ownership tokens, and/or the like.

### Conventional Mortgage and Rental Compared With Tokenization System Regarding Ownership Over Time

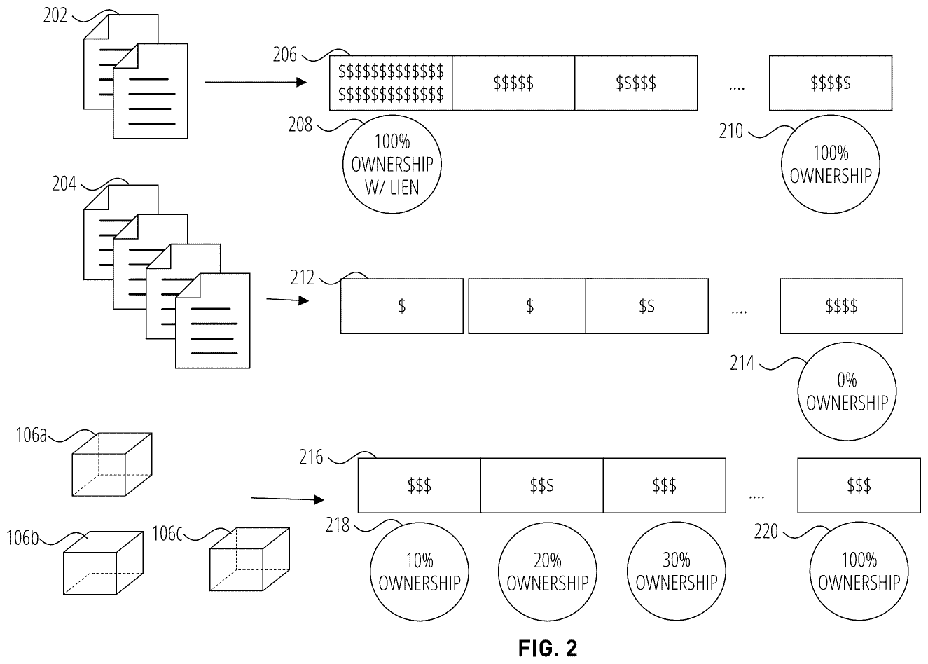

FIG. 2 illustrates an architecture comparing conventional mortgage and rental systems with the tokenization system regarding ownership of the property over time, according to some examples.

In a conventional mortgage system, the homebuyer typically pays a large down payment 206, often 20% of the home's value, and borrows the remaining 80% from a bank or other lending institution. The homebuyer gets legal 100% ownership of the property through a deed, but the lender also has a lien on the property (100% ownership with a lien 208), meaning they can foreclose and take possession if the homebuyer fails to make mortgage payments. The deed 202 is provided to the new buyer.

Integration with land record databases-The system could interface directly with public land records to submit lien documents for recording and retrieve confirmation. In some cases, the tokenization system implements self-executing smart contracts that automatically notifies relevant third party databases that have their own record (such as records of liens and ownerships), transfer lien-related assets, and/or record the lien on the blockchain upon meeting coded conditions.

In some cases, the tokenization system applies IoT sensors, such as sensors on deed documents could track their physical location and confirm when they are processed by the registrar's office. In some cases, the tokenization system applies computer vision algorithms, such as scanning deed documents and verifying registrar stamps and signatures using OCR and image analysis to validate recording (such as lien recording). In some cases, the tokenization system applies web scrapers to scrap public land record sites to check for lien recording and confirm registration details.

In some cases, the tokenization system applies Application Programming Interfaces (API) that interface with registrar's office databases, and submit via API lien data and retrieve recording confirmation of lien recordation programmatically. In some cases, the tokenization records the lien on a distributed ledger, such as recording the lien cryptographically on a blockchain to decentralized ledger.

Over the term of the loan, which could be 15 to 30 years, the homebuyer pays off the borrowed amount along with interest. The interest payments can significantly increase the total amount the homebuyer pays for the home. However, throughout this period, the homebuyer gradually gains equity in the home with each mortgage payment the homebuyer makes, and once the mortgage is fully paid, the homebuyer owns the home outright with 100% ownership 210 without a lien.

When a tenant rents a property, a contract 204 is signed between the tenant and the property owner that includes rental terms. The tenant pays a set amount 212 each month for the use of the property but gains no ownership or equity. Moreover, the rent could increase as time passes. This is typically the least costly option in the short term, as the tenant only pays for the use of the property and don't have to provide a large upfront down payment or pay interest. However, at the end of the lease, the tenant has 0% ownership 214 in the property, and all the money the tenant paid in rent does not contribute to any form of property ownership.

In contrast, the tokenization system combines elements of both mortgages and rentals while leveraging the advantages of tokenization technology. When the tenant uses this tokenization system, the tenant starts renting the property and also purchases tokens 106 over time. Each token represents a fraction of ownership in the property. Each month, the tenant makes payments 216 for the rental of the property and also for the tokens. The tenant gradually builds equity in the property (such as 10% ownership 218 initially) without needing to provide a large down payment upfront or pay high amounts of interest to a lender. Over time, and as leases renew, the tenant accumulates enough tokens to own the property outright at 100% ownership 220 without any liens and risks of default. The tokenization system provides the flexibility to move without the need to sell property, given that the tokens can be sold, transferred, and/or held. The tenant also has the ability to acquire ownership over time, thereby making homeownership more accessible for more people.

### Architectural Diagram Between the Tokenization System, Asset Owners, and Individuals

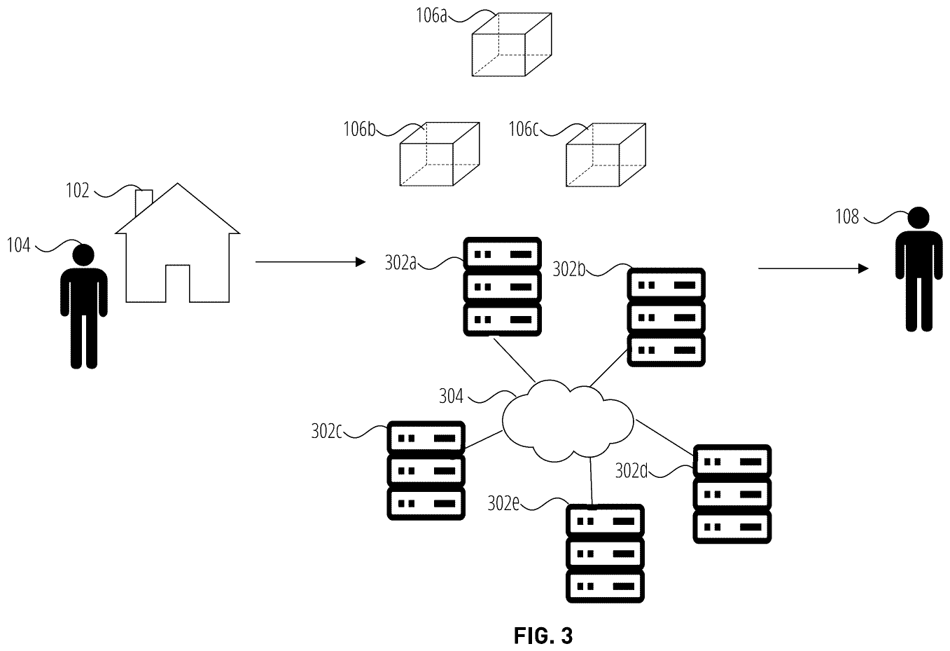

FIG. 3 illustrates an architectural diagram between the tokenization system, asset owners, and individuals, according to some examples. A group of computers 302a, 302b, 302c, 302d, and 302e (collectively referred to as the group of computers 302) connected to the Internet 304 runs the blockchain that forms a decentralized network, also known as nodes in blockchain terminology. These nodes are responsible for maintaining and updating the blockchain ledger, which in this case performs actions that record ownership, transactions, and contractual terms, and execute smart contracts for real estate properties.

When an asset owner 104 wants to tokenize their home 102, the asset owner submits the necessary documentation (such as a deed) to the tokenization system. The tokenization system receives a digital deed and performs functions using one or more forms of artificial intelligence, data processing, and cryptographic technologies.

The tokenization system receives a digital copy of the deed from the asset owner. This digital copy could be a scanned document or a photo of the physical deed. The tokenization system performs Optical Character Recognition (OCR), which can be a form of Artificial Intelligence (AI) that identifies text within digital images or scanned documents. The OCR module converts the visual representation of the text in the digital deed into machine-readable text.

Once the text has been recognized, a Natural Language Processing (NLP) module can be used to identify and extract key pieces of information. NLP, which can be another form of AI, is capable of understanding human language. In this case, the tokenization system identifies information such as the owner's name, the property description, boundaries, and any relevant legal language.

The extracted information is then standardized and stored in a structured database, enabling easy access and comparison. Standardization may involve transforming the text to conform to set formats, such as converting dates to a YYYY-MM-DD format, or geolocating addresses to standardized coordinates. Information, such as a digital copy of a deed, received from the various data sources can be of a different format.

In some cases, the machine learning model classifies the property based on the extracted information. The machine learning model identifies certain characteristics of the property that is not explicitly in the extracted information. For example, the machine learning model classifies a unit as a 1 bedroom based on its size and location.

The tokenization system configures data from multiple different databases that are in their own non-standardized format into a single standardized format. As such, messages can be automatically generated to communicate with individuals such as tenants and asset owners using the standardized format. Moreover, assessments and decisioning made by the tokenization system can be applied back to the asset owner by reapplying non-standardized formatting of the asset owner.

In some cases, the tokenization system processes the deed information into a viewable form, such as in a way which mirrors the physical representation of an original paper form of the deed. This reduces the time consuming nature of importing source code into the form. The tokenization system converts a digital copy of the deed into a standardized form which establishes calculations and rule conditions required to fill in the standardized form, import data from the digital copy to populate data fields in the standardized form, and performs calculations on the imported data. This allows the tokenization system to change imported data into a standardized viewable form.

In some cases, the tokenization system applies such standardization on documents or data received and/or documents generated. The tokenization system generates a standardized form of a deed to enable the tokenization system to generate a viewable deed form. In some cases, the tokenization system generates contracts, such as between the tenant and the asset owner, to rent and purchase tokens. The tokenization system collects data related to the tenant, asset owner, and asset from various different sources and applies standardization to this data to populate fields of the generated documents (e.g., contracts).

In some cases, the machine learning model performs one or more features of the standardization described herein. In some cases, the machine learning model performs customizations and/or standardizations based on a user's preferences. For example, the user inputs preferences such as a particular language for translation, customization on classifications and associated parameters, non-linear transformation, and/or the like.

In some cases, the tokenization system checks consistency of information between the deed and a government or public property database. The tokenization system accesses such data via an API (Application Programming Interface) to interface with the relevant public records databases, query the extracted details, and compare the results for verification purposes. This step ensures that the property details match the official records and that the person claiming ownership is indeed the legal owner.

In some cases, the tokenization system and/or machine learning model checks consistency of information between the deed and other third party databases. For example, the tokenization system checks information using global positioning system (GPS) data to verify the location, accesses photographs or data of prior owners such as on social media to verify the interior design of the home, and/or assesses a live camera feed from an augmented reality device. For example, the live camera feed can include a walk through of the property and the machine learning model applies computer vision algorithms to the camera feed to identify characteristics of the home, such as door types, bedroom locations, size, and/or the like.

Once the ownership is verified, the tokenization system divides the property's value into multiple tokens, as per the value evaluated by the system or provided by the user. These tokens represent fractional ownership in the property. The token ownership records, deed, and other relevant details are encrypted and stored on a blockchain. Each token transfer can be managed via a smart contract, ensuring that all transactions are secure, transparent, and immutable, and the tokens are made available for tenants to purchase.

In some cases, the tokenization system applies the API to perform a recordation on the property records database, such as a records database of a government entity. In some cases, the tokenization system records a lien on the property based on tokens minted for the property.

In some cases, the tokenization system creates internal property records. For example, the tokenization system uses these internal property records that enable a layer of protection (e.g., to prevent multiple entries). In some cases, the tokenization system creates an internal property record to not have to rely on public records and/or to rely on such internal records when public records are unavailable.

If the tenant becomes the full owner, the tokenization system facilitates the transfer of ownership. The tokenization system initiates a transaction via the API with the property records database, to record the new ownership, such as via a smart contract indicating full ownership. These operations are conducted securely due to the cryptographic principles of the underlying blockchain and/or tokenization technology.

In some cases, the features related to the deed and/or other features of the tokenization system applies a self-referential table. A self-referential table includes a database table where a foreign key references the primary key of the same table. The tokenization system, for example, applies such self-referential tables to track the ownership history of the tokens representing asset ownership.

Each token could be represented as a row in the table, with fields such as token_id (the primary key), current_owner, previous_owner, and originating_asset (or depositor). The previous_owner field could reference another row in the same table, indicating the previous owner of the token before the current token owner, forming a chain of ownership. Such fields can be recorded onto the digital ledger. The tokenization system uses the originating_asset to associate a token with other tokens minted by the same asset owner. Advantageously, this field helps for certain features of the tokenization system, such as exchangeability and fungibility.

When a token is transferred from one owner to another (e.g., from the asset owner to a tenant), the current_owner field of the token's row is updated with the new owner's ID. A new row is also added to the table, representing a new token owner. The previous_owner field of this new row points to the row representing the token that was just transferred, creating a link in the chain of ownership.

Moreover, the tokenization system tracks a history of ownership via the self-referential table through the previous_owner field. Starting from a row representing a token's current owner, and previous_owner fields that would lead to the previous token owners before the current owner, and so on, until a row is reached where previous_owner is null, indicating the original token issued to the asset owner. This traceability adds to the transparency and security of the system, as it provides a tamper-proof log of token ownership changes.

When tokens are resold back to the asset owner or moved to another token owner, a similar process to the token transfer can be followed. The current_owner of the affected tokens is updated, and new rows are added to represent the new token owners. In some cases, the tokenization system includes an asset_owner field. The asset_owner field always remains the same asset_owner regardless of whether tokens are sold to other individuals, unless the ownership of the asset has been changed.

The self-referential tables can include a special row and/or column within the database that stores the pointers to the other portions of the same table or other tables. Instead of having to save the benefit characteristics for each of the transactions or individuals, the tokenization system includes an entry that refers to another portion of the table or other table with the corresponding information. Advantageously, the data stored in each of the databases can be reduced by calling a call function (e.g. a database pointer) when a certain data entry in another table is needed.

Thus, a tokenization system and/or client devices can perform functions of the tokenization system and have more flexibility in assessing large datasets, which previously required a large network throughput of data and high processing speed. Moreover, a self-referential table can enable more efficient storage and retrieval of larger sized data, faster searching of the asset ownership, token distribution, and/or the like; and more flexibility in configuring the database.

In some cases, the tokenization system includes the group of computers 302 and/or facilitates communication among the group of computers 302. The nodes in the network validate information, such as ownership, and if validated, the nodes initiate the token creation process. The value of the property is divided by the chosen token value to determine the number of tokens to be minted.

These tokens 106, representing fractional ownership of the property, are issued to the asset owner (such as a tenant 108), such as to the asset owner's digital wallet. The transaction of minting and assigning these tokens is recorded on the ledger.

The nodes (such as the blockchain nodes) also manage the buying, selling, and leasing of tokens. For instance, when a tenant wants to buy tokens from an owner, the tenant submits a transaction to the network. The nodes verify the transaction, make sure the tenant has sufficient funds, and transfer the tokens from the owner's digital wallet to the tenant's. Once the transaction is validated and confirmed by the network (e.g., via the nodes), the transaction is recorded on the blockchain.

If a tenant accrues enough tokens to fully own the property, the blockchain network facilitates the transfer of ownership. The nodes of the blockchain burn or delete the tokens and update the property's ownership status on the digital ledger. The nodes validate this transaction before recording it on the blockchain. The nodes facilitate transfer over of the deed to the tenant.

When an asset owner (homeowner) decides to tokenize their property, the tokenization system evaluates the property to determine its current market value. The homeowner then provides the system with the necessary documentation (such as a copy of the deed) to confirm ownership of the property.

This information is verified by the decentralized network of computers running the blockchain, such as by accessing real estate records of ownership and/or on its own ledger of real estate ownership records. Once the information has been verified and the property's value has been established, the system will proceed with the tokenization process.

The value of the property is divided by the chosen token value (e.g., if a $300,000 property is divided into tokens each worth $100,000, 3 tokens will be minted as described above). These tokens, representing fractional ownership of the property, are digitally minted on the blockchain and assigned to the homeowner's digital wallet.

If a new tenant moves in or a lease is renewed, the system adjusts the valuation. if the value of the property increases, a certain number of additional tokens are minted and provided to the asset owner and/or the token holders associated with the property.

The homeowner may request to the tokenization system a re-evaluation of the property's value at any point, such as after significant improvements or renovations (e.g., adding a pool). If the value has changed, the system could initiate a re-tokenization process. For instance, if the property's value has increased from $300,000 to $500,000 and the token value remains at $100,000, two additional tokens would be minted and assigned to the homeowner and/or the token holders. This re-tokenization is recorded on the digital ledger.

Tokenizing real estate assets allows for flexibility in buying, selling, and transferring the tokenized assets. Individuals can trade tokens on a peer-to-peer basis on the tokenization platform, which is supported by the blockchain network. If a tenant wishes to buy tokens, they can send a transaction request to another individual who owns the tokens. The nodes verify ownership of the token and payment, and facilitate the transfer of ownership for the token.

The buyer sends the agreed upon amount (often in a form of cryptocurrency or any acceptable payment method on the platform) to the seller. Upon confirmation of payment, a smart contract is executed that transfers the tokens from the seller's digital wallet to the buyer's wallet. This transaction is recorded and verified on the blockchain, providing an immutable record and ensuring transparency.

In some cases, a buyer can buy or sell tokens directly from/to the asset owner. The asset owner lists the tokens for sale on the platform (such as with the specified price). A buyer who wishes to buy these tokens sends a purchase request, pays the specified price, and receives the tokens upon confirmation of payment via a smart contract. The smart contract ensures payment is made and tokens are owned and transferred. The asset owner can also buy back the tokens from the tenant or another token holder using a similar process.

Blockchain technology's inherent transparency, security, and immutability make it well-suited for this kind of application. Each node in the network independently verifies every transaction and maintains a copy of the ledger, making the system highly resilient and reliable. This decentralization also ensures that no single entity has control over the network, increasing trust and participation in the system using technological advances that are not typically used in real estate, let alone real estate ownership scenarios.

Intermediaries such as property developers or token aggregators could hold a pool of tokens from various properties and offer them for sale to interested buyers. The intermediary can list the tokens for sale on the platform, and buyers can purchase these tokens.

Intermediaries also can buy tokens. For instance, a token aggregator might be interested in buying tokens from various individual holders to add to their collection. Individual token holders or asset owners could sell their tokens to these intermediaries following a similar transaction process as described herein.

In these scenarios, the use of smart contracts ensures that transactions are securely executed and recorded. The blockchain's decentralized nature ensures transparency, as all transactions are visible to all participants in the network.

In some cases, the tokenization system and/or a smart contract can facilitate the use of a property. For example, a tenant can be renting a home while obtaining tokens. The tokenization system can facilitate such use by sending a message to control the property. The tokenization system sends a wireless message to a lockbox on the property enabling the user to access keys to open the home. In some cases, such messages can control the use, type of use, availability of certain operations and features, time period and duration of use, and/or the like using these communications.

The tokenization system sends such signals to a computing device or server of the asset, such as a vehicle computing device or a server communicating with one or more smart home systems.

In some cases, depending on the rules set by the platform, tokens are used across properties, meaning a token holder could potentially use their tokens as payment towards rent or purchase in another property on the platform. These features make the tokens of the tokenization system truly fungible and provide additional flexibility to the token holders.

In the context of tokenizing real estate, leasing tokens introduces a level of flexibility and unique opportunities for temporary ownership and use of assets. The tokenization system enables a token holder who owns a certain percentage of an asset to lease tokens to another individual. By doing so, the tokenization system enacts a smart contract that enables the other individual to gain temporary ownership of the tokens and, by extension, the right to use or benefit from a proportion of the asset represented by these tokens.

During the lease period, the tokenization system enables the temporary token holder to rent the property to a tenant. The proceeds from the tenant are received by the tokenization system, whereby smart contracts are invoked to provide the proceeds to the token holder and the temporary token owner. At the end of the lease, the tokenization system invokes a smart contract whereby the tokens are automatically returned to the token owner's wallet.

The distribution of rent proceeds automatically disperses via smart contracts. For instance, if the rent is paid in cryptocurrency, the smart contract automatically distributes the rent to the token owner, the temporary token owner, and property manager based on predefined percentages. For example, the property manager may require a certain amount or percentage of the proceeds.

Token leasing in this manner not only provides opportunities for passive income for token holders but also increases liquidity of the token in the token market. It further allows those without the capital to purchase tokens outright to benefit from tokenized assets temporarily.

Token holders in a real estate tokenization system have various investment strategies at their disposal. The token holders can engage in arbitrage, where they buy and sell tokens to take advantage of price discrepancies across different markets or platforms, turning a profit from the difference in token prices. This might occur if tokens representing the same asset are priced differently in distinct markets.

Token holders can adopt a long-term investment strategy, holding onto tokens to benefit from natural appreciation of the underlying real estate asset. In some cases, over time, as the property value increases, so does the value of each token, providing capital gains to the token holders. In some cases, new tokens are minted and distributed to each owner accordingly, such as if there are multiple owners to a property management company or to multiple properties. Token holders can also deposit or lease their tokens to others, earning a passive income. This approach allows others to use the tokens temporarily, such as for rental income, while the original token holder continues to derive financial benefit.

In some cases, the asset owner divides the value of a single asset (say, a house) into several tokens. Each token represents a proportional stake in the returns from the asset (like rent). The tokenization system enables transfer of property ownership to a token holder who accumulates tokens equivalent to the asset's total value. In such a case (e.g., in response to transfer of the ownership), the tokens corresponding to that asset are removed from circulation or “purged.”

In some cases, the tokenization system enables an asset owner to have several assets (say, multiple properties). Here, the total value of all assets is divided into tokens, each representing a proportional stake in the returns from all assets. Alternatively, each individual asset can also have its own token representation. The tokenization system enables token holders to acquire ownership of an individual asset or a percentage of a group of assets by accumulating tokens equivalent to the asset's total value. In some cases, different owners of the same or different properties can each tokenize their equity and/or ownership.

This kind of tokenized asset ownership provides investors with a new way to diversify their portfolios and potentially lower barriers to entry in markets like real estate using the technological advances of tokenization.

Although examples described herein refer to asset or real estate property, it is appreciated that examples described herein can refer to other types of assets, including both physical and/or intangible assets. For example, assets can refer to vehicles, such as cars, boats, planes, and other vehicles, allowing investors to own a piece of these assets and potentially share in their appreciation over time.

In some cases, the assets refer to artwork and/or collectibles, such as paintings, sculptures, rare collectibles, and other valuable items that can be tokenized to enable broader ownership. This could lower the barriers to entry in the art investment market, which has traditionally been accessible only to the wealthy.

In some cases, assets refer to intellectual property, such as copyrights, patents, and other forms of intellectual property. This could enable creators to raise funds while allowing investors to share in the potential profits from these assets.

In some cases, assets refer to commodities such as gold, oil, or agricultural products, providing another way for investors to gain exposure to these markets. In some cases, assets refer to business equity, allowing investors to buy and sell tokens representing shares in the company. In some cases, assets refer to debt instruments, such as bonds or loans, which could create more flexibility and liquidity in the debt market. In some cases, assets refer to digital assets such as domain names, digital art (such as non-fungible tokens—NFTs), and in-game assets.

### Progressive Ownership Through Asset Utilization

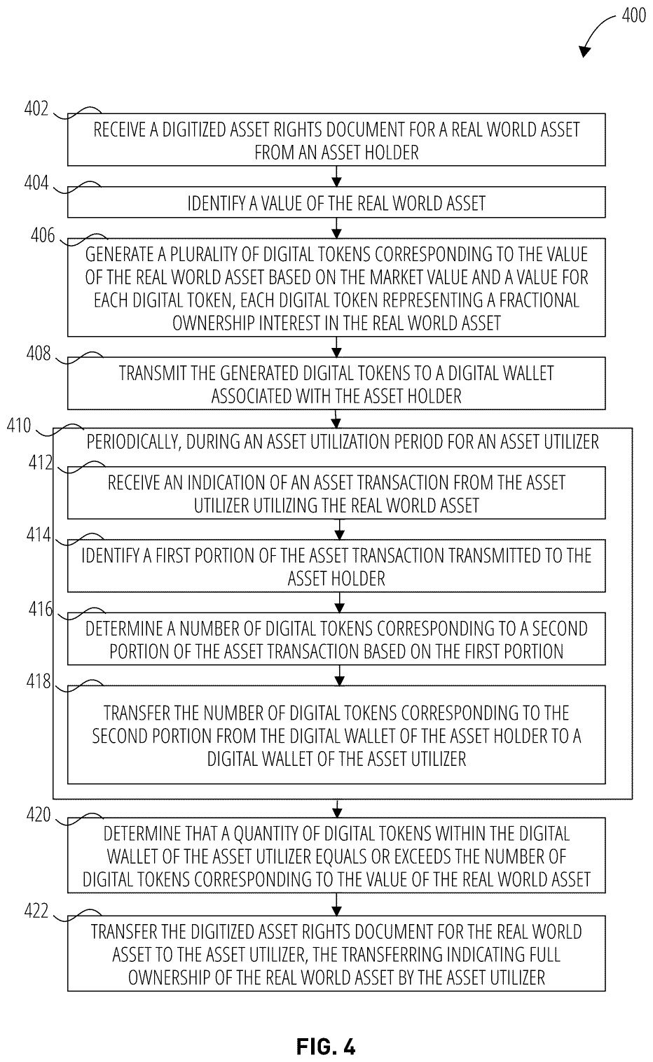

FIG. 4 illustrates an example method 400 for progressive ownership through asset utilization using the tokenization system, according to some examples. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

At block 402, the tokenization system receives a digitized asset rights document for a real world asset from an asset holder. The tokenization system acquires a digital representation of the legal rights associated with a tangible asset, provided by the individual or entity that currently holds those rights. The tangible asset can be any form of real-world property, such as real estate, vehicles, artwork, or other valuable goods.

In some cases, the real world asset includes a real estate property, such as a home, a building 506, a car 504, equipment such as recording equipment 508, material such as gold or steel, technology such as a server or radio station, and/or the like. The real world asset can include any real world object that can be tokenized based on its value.

The digitized asset rights document includes a legal document that establishes the ownership and rights associated with the asset. This could be a deed for a property, a title for a vehicle, or any other legal document that establishes ownership.

The process of digitizing this document involves taking a picture or scanning a physical copy of the asset rights document. The tokenization system converts the information within the digitized asset rights document into a digital format that can be stored, transmitted, and processed electronically. In some cases, the tokenization system scans the digitized asset rights document and applies optical character recognition (OCR) to extract text.

The tokenization system can apply a machine learning model to map data fields in the digitized asset rights document to relevant data fields in the tokenization system database. In some cases, the tokenization system standardizes data in the digitized asset ownership document. For example, formats and data can be different across different documents, such as abbreviations, acronyms, and/or formats (e.g., zipcodes). The tokenization system standardizes such data, such as using a machine learning model, in order to store and process the data.

With data in standardized format, the tokenization system can compare data to other data in its database. If the tokenization system desires to send data back to the computing system that transmitted the digitized asset ownership document or other third party databases, the tokenization system converts the data into the non-standardized format of the receiving party.

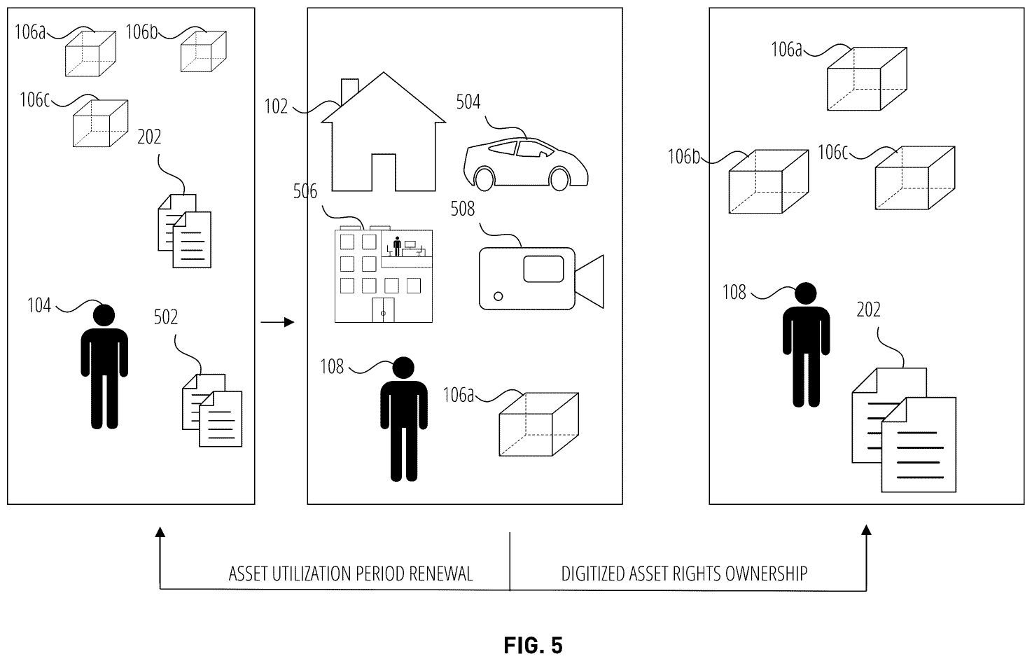

FIG. 5 illustrates an architectural diagram of progressive ownership, according to some examples. The asset owner 104 provides a digitized asset rights document (such as a deed 202) to the tokenization system.

At block 404, the tokenization system identifies a value of the real world asset. The tokenization system determines a monetary worth of the real world asset. The tokenization system determines the value of the asset through one or a variety of ways. In some cases, the tokenization system determines the value of the asset depending on the type of asset. For instance, in the case of real estate, the value could be determined through a professional appraisal system, comparative market analysis, or valuation models.

In some cases, the tokenization system applies a valuation model, such as a machine learning model. The tokenization system inputs one or more characteristics of the home. The tokenization system identifies such characteristics based on information from the digitized asset ownership document and/or third party databases. For example, the tokenization system can retrieve an address from the digitized asset ownership document and retrieve characteristics of the property, such as the number of bedrooms, square footage, and/or the like from third party databases.

In some cases, the tokenization system inputs characteristics of the asset into the model, such as the condition, size, location, address, characteristics of the neighborhood, and other factors. The model is trained to identify similar properties (such as properties in a similar neighborhood that share certain characteristics of the asset) and compares the property to these other similar properties that have recently sold in the same area to determine its estimated market value.

In some cases, the valuation models use mathematical modeling combined with databases of existing properties and transactions to calculate property values. These models can quickly provide an estimate of a property's value based on available data. This value serves as the basis for generating the digital tokens that represent ownership of the asset. This value is also used by the tokenization system, machine learning models, and/or smart contracts in accepting transactions if the value is within an acceptable range of values.

At block 406, the tokenization system generates a plurality of digital tokens corresponding to the value of the real world asset. For example, the tokenization system generates digital tokens based on the market value and a value for each digital token. Each digital token represent a fractional ownership interest in the real world asset.

The tokenization system creates (or mints) digital tokens that represent fractional ownership in the tangible real world asset. These tokens are generated in a quantity that corresponds to the previously determined value of the asset.

The tokenization system identifies a value for each digital token. The tokenization system can set the price of each digital token, the price can be set by a user such as the asset owner, and/or the price can be set by the market (such as based on buy and sell orders on an exchange that exchanges tokens for other monetary value such as money). The token price can be a standard value across all assets, and/or it could vary based on factors such as the type of asset, the total value of the asset, or market conditions.

Once the value per token is identified, the system determines the number of tokens to be generated that corresponds to the value of the asset. For example, the tokenization system divides the total value of the asset by the value of each token. For example, if a property is worth $100,000 and each token is worth $100, the system would generate 1,000 tokens. In another example, 3 tokens are considered equal value to the home, and the tokens 106 of FIG. 5 are generated by the tokenization system.

Each of these tokens represents a fractional ownership interest in the asset. For instance, in the above example, each token would represent a 0.1% ownership interest in the property.

The tokenization system can initiate a distributed ledger and/or blockchain technology to generate the tokens. The tokenization system initiates the blockchain to create unique, non-fungible tokens that can be securely tracked and transferred. Each token is a digital asset that is stored on the blockchain, providing a transparent and immutable record of ownership.

Once generated, these tokens can be bought, sold, or traded, allowing for the fractionalization of ownership in the asset. This enables individuals to invest in expensive assets such as real estate without needing to purchase the entire asset outright or having to make a large down payment and signing onto a mortgage. The tokenization system also provides a mechanism for transferring ownership of the asset over time, as individuals can gradually acquire tokens until they own a majority or the entirety of the tokens associated with the asset.

At block 408, the tokenization system transmits the generated digital tokens to a digital wallet associated with the asset holder. A digital wallet includes a software-based system that securely stores users' digital assets, such as cryptocurrencies and/or asset-backed tokens.

The tokenization system initiates the transmission process once the digital tokens have been generated. The tokenization system initiates a transaction on the blockchain network to move the tokens from the system's wallet (or a temporary holding wallet) to the asset holder's wallet.

The tokenization system initiates the creation of a digital signature using its private key, which is then broadcasted to the blockchain network. The network's nodes validate the transaction, ensuring that the tokenization system has the necessary balance of tokens to perform the transaction and that the digital signature matches the system's public key.

Once validated, the transaction is added to a block of transactions, which is then added to the blockchain. This process ensures the immutability and transparency of the transaction, providing a clear record of the transfer of tokens from the system to the asset holder.

The asset holder's digital wallet will then update to reflect the receipt of the new tokens. The asset holder then manages these tokens within their wallet, including transferring them to other wallets or using them in transactions.

At block 410, the tokenization system performs certain steps periodically, during an asset utilization period for an asset utilizer, such as blocks 412, 414, 416, and/or 418. At block 412, the tokenization system receives an indication of an asset transaction from the asset utilizer utilizing the real world asset at block 412.

The tokenization system periodically receives signals or notifications of asset transactions from the asset utilizer during a specified period of asset utilization. The asset utilizer could be a tenant, a renter, or any other party who is using the real-world asset but does not fully own it.

The tokenization system can receive asset transactions that can relate to one or more different actions related to the use or partial acquisition of the asset. For instance, the tokenization system receives an indication of a rent payment, a purchase of additional tokens representing ownership in the asset, or the like. In some cases, the tokenization system determines such payment is made from a third party financial database or server. In other cases, the payment is made directly to the tokenization system.

The tokenization system receives the indication of the asset transaction via digital signal or message sent from the asset utilizer's digital wallet or account to the system. The indication includes information about the transaction, such as the amount paid, the number of tokens purchased, and the time of the transaction.

The tokenization system receives this indication and processes it to update the records of the asset and the associated tokens. The tokenization system updates the balance of tokens in the asset utilizer's digital wallet, updating the remaining value of the asset, and/or updating the record of payments made by the asset utilizer.

At block 414, the tokenization system identifies a first portion of the asset transaction transmitted to the asset holder. This first portion could represent a variety of things depending on the specifics of the transaction and the terms of the asset utilization. For instance, in a rental scenario, the first portion represents the part of the tenant's payment that is allocated towards rent, while the remainder could be allocated towards other costs, such as the purchase of tokens.

The tokenization system transmits the first portion of the asset transaction to the asset holder. In some cases, tokenization system identifies a payment made through other channels, such as assessing a financial transaction from the asset utilizer to the asset holder.

The tokenization system identifies this first portion by analyzing the details of the transaction indication received from the asset utilizer. This could involve parsing the transaction data, applying predefined rules or algorithms, or using machine learning models to classify and quantify the different parts of the transaction.

Once the first portion is identified, the payment is recorded in the system and used to update the records of the asset and the associated tokens. This involves subtracting the value of the first portion from the asset transaction.

At block 416, the tokenization system determines a number of digital tokens corresponding to a second portion of the asset transaction based on the first portion. The second portion of the asset transaction can represent the part of the payment that is allocated towards the purchase of tokens, which represent fractional ownership in the asset. In contrast, the first portion, as identified in the previous step, can represent the part of the payment that is allocated towards other costs, such as rent or to the property manager.

In some examples, a portion of the asset transaction is sent to the property manager. If the asset owner is the property manager, the tokenization system sends the portion of the asset transaction for rent and for property management to the asset owner. If the property manager is a third party, the tokenization system sends separate payments to the property manager and to the asset owner.

The tokenization system determines the number of tokens corresponding to the second portion by dividing the value of the second portion by the value of each token. For example, if the second portion of the payment is $1000 and each token is worth $100, the system would determine that the second portion corresponds to 10 tokens.

At block 418, the tokenization system transfers the number of digital tokens corresponding to the second portion from the digital wallet of the asset holder to a digital wallet of the asset utilizer. The tokenization system facilitates the transfer of a specific number of digital tokens from the digital wallet of the asset holder to the digital wallet of the asset utilizer, such as token 106a to the tenant 108.

In some cases, the transfer process begins with the tokenization system initiating a transaction on the blockchain network. This transaction involves moving the specified number of tokens from the asset holder's wallet to the asset utilizer's wallet.

The tokenization system creates a digital signature for the transaction using the private key associated with the asset holder's wallet. This signature is then broadcasted to the blockchain network, where it is validated by the network's nodes. The nodes check that the asset holder's wallet has a sufficient balance of tokens and that the digital signature matches the public key associated with the wallet.

Once validated, the transaction is added to a block of transactions, which is then added to the blockchain. This process ensures the immutability and transparency of the transaction, providing a clear record of the transfer of tokens from the asset holder to the asset utilizer.

In some cases, in response to a lapse of the asset utilization period for the asset utilizer, the tokenization system determines whether the quantity of digital tokens within the digital wallet of the asset utilizer equals or exceeds the number of digital tokens corresponding to the value of the real world asset. In response to determining that the quantity of digital tokens within the digital wallet of the asset utilizer does not equal or exceed the number of digital tokens corresponding to the value of the real world asset, the tokenization system renews the asset utilization period.

In some cases, the tokenization system automatically renews the asset utilization period. In other cases, the tokenization system generates a new contract to be agreed upon between the asset owner and the tenant for a new asset utilization period.

The asset utilization period can include a predefined time period, such as a lease term or a use term, during which the asset utilizer is expected to acquire full or partial usage rights, and full and/or partial ownership of the asset by purchasing tokens.

The tokenization system retrieves the current balance of tokens in the asset utilizer's digital wallet and compares it to the total number of tokens that correspond to the full value of the real-world asset.

If the system determines that the balance of tokens in the asset utilizer's wallet does not equal or exceed the total number of tokens, the tokenization system determines that the asset utilizer has not yet acquired full ownership of the asset. In this case, the tokenization system renews the asset utilization period, allowing the asset utilizer more time to acquire the remaining tokens.

The renewal of the asset utilization period involves extending the lease term, renewing the loan term, and/or setting a new deadline for the asset utilizer to acquire full ownership. This provides flexibility for the asset utilizer and allows them to continue using the asset and acquiring tokens towards full ownership.

At block 420, the tokenization system determines that a quantity of digital tokens within the digital wallet of the asset utilizer equals or exceeds the number of digital tokens corresponding to the value of the real world asset. For example, the tenant 108 has acquired all tokens, tokens 106a, 106b, and 106c for the home 102.

The tokenization system checks the balance of digital tokens in the asset utilizer's digital wallet and compares the amount to the total number of tokens that correspond to the full value of the real-world asset.

The tokenization system retrieves the current balance of tokens in the asset utilizer's digital wallet. In the case where a distributed ledger is used, the tokenization system queries the blockchain network for the wallet's address and retrieving the associated balance. The tokenization system compares this balance to the total number of tokens that were initially generated to represent the full value of the asset.

In some cases, the tokenization system reassesses a total number of tokens based on the current price of the asset. For example, the asset appreciates (or depreciates) naturally over time. In some cases, modifications or damage occurs to the asset over time, and thus the value appreciates or depreciates.

If the balance of tokens in the asset utilizer's wallet equals or exceeds the total number of tokens, the tokenization system determines that the asset utilizer has acquired full ownership of the asset. This could be the result of the asset utilizer gradually purchasing tokens over time, or of one or more large transactions in which the asset utilizer purchases some or all of the required tokens.

In some cases, the full ownership occurs automatically when balance of tokens in the asset utilizer's wallet equals or exceeds the total number of tokens. In some cases, the asset utilizer is provided the option to acquire the asset upon reaching the required number of tokens.

At block 422, the tokenization system transfers the digitized asset rights document for the real world asset to the asset utilizer, such as the deed 202 in FIG. 5. The transferring indicates full ownership of the real world asset by the asset utilizer.

This transfer is triggered when the tokenization system determines that the quantity of digital tokens in the asset utilizer's digital wallet equals or exceeds the total number of tokens corresponding to the full value of the asset, indicating that the asset utilizer has acquired full ownership.

The digitized asset rights document includes a digital version of a deed, title, or other legal document that establishes ownership of the asset. This document is stored in a secure, tamper-proof format of the tokenization system, such as a blockchain or a secure database.

The tokenization system initiates the transfer by creating a transaction on the blockchain or updating the database to reflect the change in ownership. The tokenization system can change the owner field in the asset rights document to the identifier of the asset utilizer, or creating a new asset rights document with the asset utilizer as the owner and invalidating the previous document.

The tokenization system initiates broadcasting of the transaction or update to the network or commits the change to the database, where it is validated and recorded. This process ensures the immutability and transparency of the ownership transfer, providing a clear and indisputable record of the asset utilizer's ownership.

Once the transfer is complete, the asset utilizer has full legal ownership of the asset, as represented by the digitized asset rights document. The asset utilizer becomes the new asset owner and can exercise all rights and privileges associated with ownership, such as selling the asset, using it as collateral, or making modifications to the asset.

### Asset Right of Use and Ownership

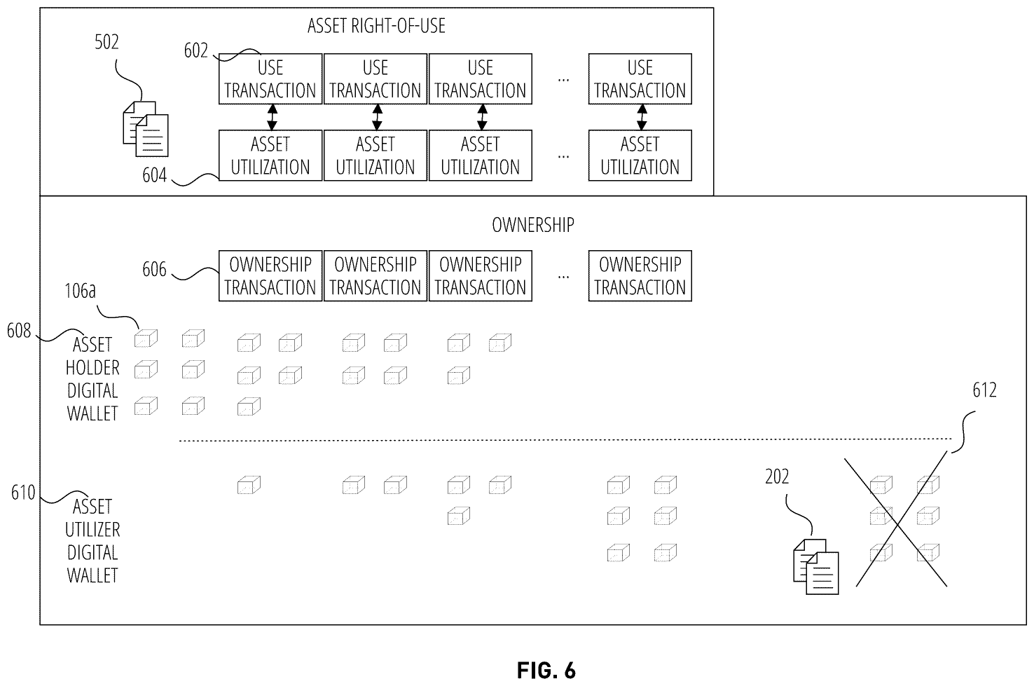

FIG. 6 illustrates an example architecture for the right of use and ownership of an asset, according to some examples. The asset holder provides a digitized asset rights document 502, such as a deed, to the tokenization system.

Subsequently to the tokenization system receiving the digitized asset rights document, the tokenization system identifies a value of the real-world asset. This could involve using data from the asset rights document, such as the purchase price or the assessed value, obtaining an independent appraisal, and/or performing market analysis (e.g., using models such as machine learning models).

The system then generates a plurality of digital tokens, such as token 106a corresponding to the value of the real-world asset. Each token represents a fractional ownership interest in the asset. The number of tokens is determined by dividing the value of the asset by the value of each token. Once the tokens are generated, the tokenization system transmits the tokens to an asset holder's digital wallet 608.

In some cases, the asset utilizer, such as a tenant, submits a use transaction 602 to the system. This transaction enables the tenant's asset utilization 604. The use transaction could include various details, such as the amount of the payment, the period of time for which the payment covers the use of the asset, and the specific portion of the asset that the tenant is paying to use. For example, the tenant could be paying to use the whole house, a specific room, or the asset during a specific period of time.

In some cases, the tokenization system automatically enables access to the asset. For example, the tokenization system automatically configures digital locks or security systems. In some cases, the tokenization system generates a unique access code for the asset utilizer upon receipt of the use transaction. The tokenization system sends the asset utilizer this code, allowing them to access the property.

In some cases, the tokenization system uses smart contracts on the blockchain to automatically grant access rights to the asset utilizer. The smart contract is programmed to change the status of the asset to ‘in use’ by the asset utilizer upon receipt of the use transaction. Such a status initiates (and/or the smart contract initiates configuration of) proper technology, as described herein, to enable access to the property.

In some cases, the tokenization system configures Internet of Things (IoT) devices that are connected to the asset. The tokenization system sends commands to these devices to grant access to the asset utilizer. For example, the tokenization system sends a command to unlock the doors of a rental property or to activate utilities of a car.

For assets such as rental properties or shared spaces, the tokenization system integrates with existing reservation platforms. Upon receipt of the use transaction, the tokenization system automatically books the property for the asset utilizer for the agreed-upon period.

In some cases, the tokenization system generates legal documents, such as lease agreements, that grant the asset utilizer the right to use the property. In some cases, the tokenization system generates such documents by identifying relevant data fields and populating the fields with information retrieved. The tokenization system applies the standardized data (as described further herein) to the forms to generate legal documents for the parties to sign.

In some cases, the tokenization system applies a machine learning model to generate such legal documents. The machine learning model is trained to receive information related to the asset, the asset holder, and/or the asset utilizer, and generate legal documents, based on training on historical asset, asset holder, and asset utilizer data.

In addition to the use transaction, the asset utilizer can also choose to purchase tokens that represent equity in the asset in an ownership transaction 606. This could be done at the same time as the use transaction, or it could be done separately. Such ownership transaction 606 can occur as a separate transaction or in the same transaction as the use transaction 602. The number of tokens that the tenant purchases is determined by the amount of monetary value the tenant applies divided by the token value. For example, if each token is worth $100 and the tenant chooses to put $100 towards equity, then as shown in FIG. 6, one token is transferred from the asset holder digital wallet 608 to the asset utilizer digital wallet 610.

The system processes the use transaction and the token purchase by updating the blockchain or the database to reflect the new token ownership. This could involve the blockchain debiting the tenant's account for the amount of the use transaction and the token purchase, crediting the asset holder's account for the asset utilization, debiting the asset holder's digital wallet of one token, and crediting the asset utilizer's digital wallet of the one token.

In some cases, the asset utilizer does not have the ability to sell tokens purchased through the ownership transactions during pendency of use. In other cases, the asset utilizer has the ability to exchange the tokens for other things of monetary value, such as money. The asset utilizer can sell the tokens back to the asset holder and/or on the open market. Upon sale of the tokens, other third parties can own the tokens. In some cases, these third parties now are fractional owners of the real world asset. In other cases, these third parties instead are owners of equity that can be applied to other similar real world assets.

The tokenization system determines that the asset utilizer has sufficient tokens to gain ownership of the home by comparing the quantity of digital tokens within the asset utilizer's digital wallet to the number of digital tokens corresponding to the value of the real-world asset. Upon determining that the asset utilizer has sufficient tokens, the tokenization system initiates the transfer of ownership.

In some cases, the tokenization system updates the digitized asset rights document, such as a deed or title, to reflect the asset utilizer as the new owner. The tokenization system creates a new digitized asset rights document with the asset utilizer's name and invalidating the previous document, or by updating the owner field in the existing document. The updated asset rights document is then recorded on the blockchain or in the database, providing a clear and indisputable record of the asset utilizer's ownership.

In some cases, the tokenization system leaves the tokens in the asset utilizer digital wallet. In other cases, the tokenization system purges 612 the tokens from circulation. If the tokenization system keeps the tokens in the asset utilizer digital wallet, the asset utilizer can use them to rent the asset to another tenant, effectively becoming the new asset holder. If the tokens are purged, the tokenization system removes the tokens from the asset utilizer's digital wallet and update the blockchain or database to reflect the reduced supply of tokens. Advantageously, purging of the coins prevents the asset utilizer from selling the property using the tokens and/or selling the property separately using the asset ownership document.

In some cases, the asset utilizer can determine an amount of tokens remaining until full ownership and make a full transaction to own the required tokens. For example, in the middle of the asset utilization period, the asset utilizer owns 4 tokens but needs 6 more for full ownership. The asset utilizer can initiate a transaction to purchase all 6 tokens. The tokenization system can then initiate completion of asset ownership transfer at that time.

Examples described herein are described according to one real world property. However, it is appreciated that the examples and features can apply to a collection of assets, such as a portfolio of properties owned by a developer or a real estate company. In this case, the “real world asset” referred to herein include multiple individual assets, each of which could be a separate property.

The asset holder provides digitized asset rights documents for each property in the collection. The system identifies the total value of the collection of properties. The system generates digital tokens corresponding to the total value of the collection of assets. Each token represents a fractional ownership interest in the entire collection, not just a single property. Thus, an asset utilizer who purchases tokens is gaining equity in the entire collection of properties, not just one property.

The asset utilizer is able to use one of the real world assets in the collection, such as by renting a property. The system checks whether the quantity of tokens in the asset utilizer's digital wallet equals or exceeds the number of tokens corresponding to the value of the collection of assets. If it does, the tokenization system transfers full ownership to the collection of properties to the asset utilizer. The system transfers the digitized asset rights documents for the entire collection of assets to the asset utilizer.

This approach allows a developer or real estate company to tokenize a portfolio of properties and sell fractional ownership interests to multiple asset utilizers. It provides a flexible and efficient way for asset utilizers to gain equity in a collection of properties, and it allows the asset holder to raise capital by selling tokens.

The system ensures proper ownership transfer by maintaining a clear and immutable record of all transactions related to the asset, including the initial tokenization of the asset and all subsequent transfers of tokens. This record serves as a digital chain of title, providing a transparent history of the asset's ownership.

When the asset holder first submits the digitized asset rights document (such as a deed) to the system, the system records this transaction on the blockchain or in a secure database. This initial record includes the asset holder's identity, the value of the asset, and the number of tokens generated.

Each time tokens are transferred from one digital wallet to another, the system records the transaction. This includes transfers from the asset holder to the asset utilizer (such as a tenant), as well as any subsequent transfers between different asset utilizers. Each record includes the identities of the sender and receiver, the number of tokens transferred, and the time of the transfer.

When the quantity of tokens in the asset utilizer's digital wallet equals or exceeds the total number of tokens corresponding to the value of the asset, the system recognizes this as a transfer of ownership. In other cases, the system provides the option of transfer of ownership. The system updates the digitized asset rights document to reflect the asset utilizer as the new owner and records this transaction.

The system maintains a complete record of all these transactions, creating a digital chain of title for the asset. This chain of title provides a clear and indisputable history of the gradual change in asset's ownership as well as the final transfer of full ownership.

By maintaining this digital chain of title, the system ensures that the ownership transfer is transparent, secure, and legally valid. The blockchain technology used in this process provides additional security by making the record immutable, meaning it cannot be altered or deleted once it's been recorded. This prevents fraud and disputes over ownership, providing peace of mind for all parties involved.

In some cases, the tokenization system generates legal documents to formalize each transfer of ownership. For example, when the asset utilizer acquires enough tokens to become the owner, the system could generate a new deed or title in the asset utilizer's name for the asset utilizer and the asset holder to sign. This document would be legally binding and could be recorded with the appropriate government agency.

In some cases, the tokenization system applies a machine learning model that is trained to generate required documents for a particular property. For example, the machine learning model generates different documents for an apartment complex, a single family home, a commercial property, or for an automobile. In some cases, the machine learning model generates documents required for different jurisdictions, such as based on state law or documents needed for foreign jurisdictions.

In some cases, upon the asset utilizer acquiring enough tokens, the system uses a third-party escrow system to hold the digitized asset rights document and oversees the transfer of ownership. The escrow system ensures that the asset utilizer has enough tokens before transferring the document to them.

In some cases, the tokenization system uses digital signatures to authenticate each transaction. Both the sender and receiver of tokens signs each transaction (such as with their private keys), providing a secure and verifiable record of the transaction.

In some cases, the system integrates online notary systems to notarize the transfer of ownership. This would provide an additional layer of legal assurance that the transfer is valid.

In some cases, the system automatically records, such as at a government agency database, a change of ownership. For example, the government agency database can hold a chain of title for a real estate property. The tokenization system initiates transmission of a message to the government agency database for the recordation of the new ownership to add to the chain of title.

In some cases, the system creates a new token recordation system that replaces and/or augments a centralized database, such as a government agency database. This can be useful if government agency databases are not complete and/or if no database currently exists.

In some cases, the tokenization system applies a machine learning model to optimize various aspects of the tokenization system. In some cases, the tokenization system applies historical data to the machine learning model, such as historical digital physical property titles, historical contracts between the owner and user of the real world asset, and/or the like and trains the model to generate an optimal asset transaction, such as an amount or value of the asset, and/or usage duration of the asset. The tokenization system uses the amount or value of the asset to verify a transaction as being within an acceptable range of the valuation.

The tokenization system trains a machine learning model using previous real estate contracts associated with different properties. Based on various factors such as property value, location, market conditions, historical trends, and more, the machine learning model is trained to estimate an optimal transaction amount and/or contract duration for a new property that's being tokenized.

For example, if the property is similar to previous assets, the machine learning model is trained from historical data to suggest terms based on an assessment of what happened for the previous assets. The machine learning model is trained to determine how quickly tokens were purchased for past property, any trends in token purchases, and so forth, to suggest a contract duration. Similarly, the machine learning model is trained to look at token prices in relation to the property value to suggest an optimal token price.

In some cases, the machine learning model is trained to perform one or more features of the tokenization system on assets that are non-similar. The machine learning model receives as input various characteristics of multiple properties, generate hidden latent variables across the different properties that factor into valuation, and applies such latent variables to compare properties that are dissimilar.

The tokenization system applies such models for the benefit of various entities. The tokenization system can help the asset holder in determining the parameters for their token offering. The tokenization system can help the tenant in evaluating different tokenization offers and finding the one that matches their financial capacity and goals. The tokenization system also applies such models to smart contracts to verify transaction by ensuring the values are within the range of values that the machine learning model estimates or outputs.

In some cases, the tokenization system trains a machine learning model by applying input lease agreements associated with different assets to determine the forecast expected total cost to a tenant for ownership and provide a comparison for different options.

The tokenization system trains a machine learning model to analyze past contracts and/or current market conditions to forecast a value a tenant could expect to submit over time to gain ownership of a property using the digital tokens. The machine learning model is also trained to compare this total value against other options, such as compared to traditional home buying or other tokenized processes.

The tokenization system trains a machine learning model to use various inputs such as the property's token price, the length of the contract, market trends, and other relevant data. The model can process this information to generate a projection of total value to be submitted and uses this forecast to compare different home ownership options. The tokenization system helps tenants make informed decisions about the most cost-effective way to gain homeownership.

In some cases, the tokenization system trains a machine learning model to review a smart contract and translate the contract into a form aligned with certain tenant specified criteria. Smart contracts include self-executing contracts with the terms of the agreement directly written into code. The smart contracts detail the terms of the tokenization agreement, including token price, number of tokens, contract duration, and/or the like.

The machine learning model receives the smart contract code as input and translate the code into a format that aligns with the tenant's specific criteria or requirements, such as reinterpreting the terms into a more readable format, highlighting key terms and conditions, or mapping terms to specific criteria set by the tenant.

As such, the tokenization system applies such a machine learning model to help tenants to quickly understand the terms of various tokenization contracts, and how they align with their specific needs and goals. It would make the process of comparing and choosing between different tokenization options more accessible and user-friendly.

Although the machine learning model is described to perform certain steps herein, it is appreciated that the machine learning model can facilitate and/or perform one or more features of the tokenization system, such as asset valuation, generation of tokens, transmitting of tokens from one wallet to another, providing usage to an asset user, and/or the like.

### One Million Dollar Home Transferring Ownership

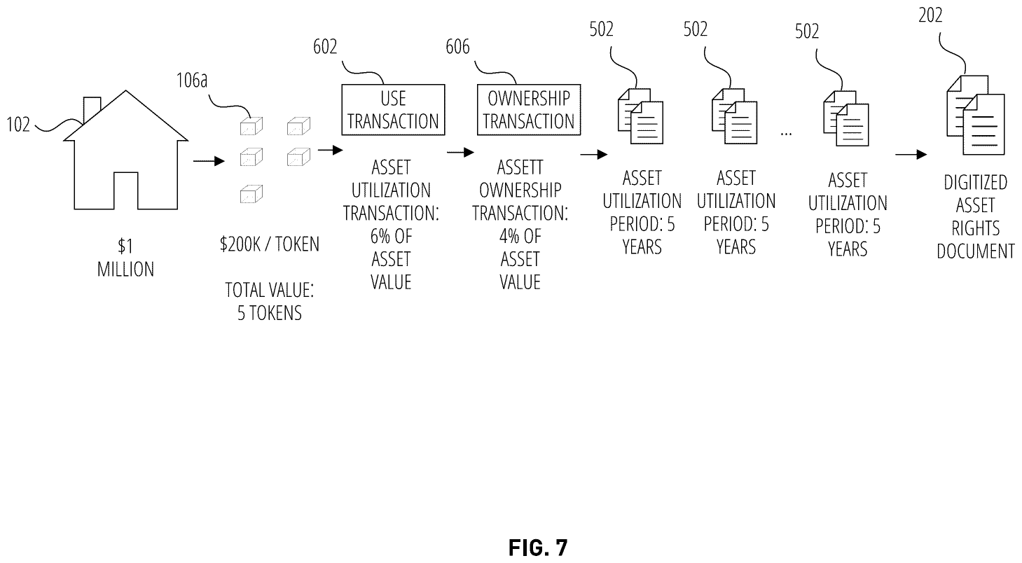

FIG. 7 illustrates an example of a home valued at $1,000,000 gradually changing ownership to an asset utilizer, according to some examples. The home 102 is worth $1 million in FIG. 7. The tokenization system divides the total value of the house into a number of equally valued tokens. Each token 106 is worth $200,000, and since the house is worth $1 million, a total of 5 tokens are minted. These tokens are then transferred to the digital wallet of the asset holder. Each token represents a 20% ownership interest in the house.

The asset utilizer pays 6% of the asset value in a use transaction 602 for use of the asset. The asset utilizer (e.g., a tenant) pays a fee to use the asset. This fee gives the asset utilizer the right to use the asset for a specified period of time.

The asset utilizer pays 4% of the asset's value, which is an additional payment to acquire ownership tokens. In return for this payment, the asset utilizer receives a fraction of the total tokens. The exact number of tokens they receive would depend on the value of each token. In some cases, the tokenization system and/or the property owner provides a discount to the asset value to encourage purchase of the property. In some cases, the tokenization system adds a premium value to each token to discourage purchase of the property.

The tokenization system or other party sets a time period is set for the asset utilization, such as 5 years. The tokenization system generates a digitized asset rights document 502 (such as a lease contract) between the asset utilizer and the asset holder. During this time, the asset utilizer has the right to use the asset and can continue to acquire ownership tokens. The length of the utilization period can vary depending on the terms agreed upon by the asset holder and the asset utilizer.

At the end of the 5-year utilization period, the lease agreement is renewed. The renewal of the agreement allows the asset utilizer to continue using the asset and acquiring ownership tokens.

Over time, through many recurring transactions, the asset utilizer acquires all of the tokens that represent the value of the asset. Once the asset utilizer has acquired all of the tokens, the asset utilizer effectively owns the asset entirely. At this point, the digitized asset rights document, which could be a deed 202 or title, is transferred from the asset holder to the asset utilizer. This transfer indicates that the asset utilizer now has full ownership of the asset.

### Machine Architecture

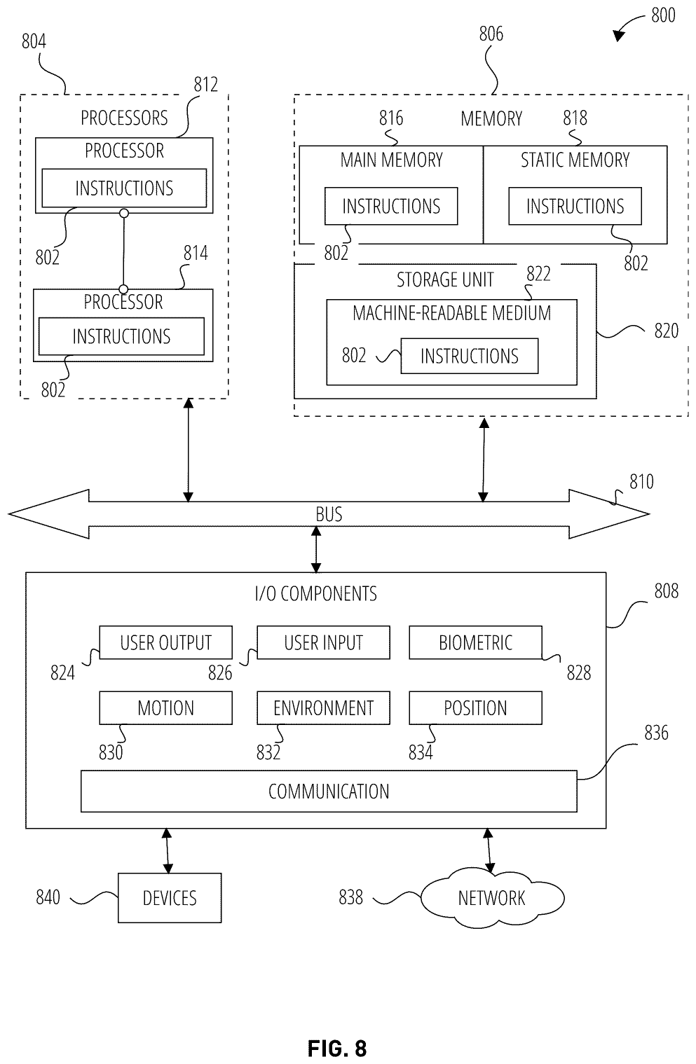

FIG. 8 is a diagrammatic representation of the machine 800 within which instructions 802 (e.g., software, a program, an application, an applet, an app, or other executable code) for causing the machine 800 to perform any one or more of the methodologies discussed herein may be executed. For example, the instructions 802 may cause the machine 800 to execute any one or more of the methods described herein. The instructions 802 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 802, sequentially or otherwise, that specify actions to be taken by the machine 800. Further, while a single machine 800 is illustrated, the term “machine” shall also be taken to include a collection of machines that individually or jointly execute the instructions 802 to perform any one or more of the methodologies discussed herein. The machine 800, for example, may comprise a user system or any one of multiple server devices forming part of the server system. In some examples, the machine 800 may also comprise both client and server systems, with certain operations of a particular method or algorithm being performed on the server-side and with certain operations of the particular method or algorithm being performed on the client-side.

The machine 800 may include processors 804, memory 806, and input/output (I/O) components 808, which may be configured to communicate with each other via a bus 810. In an example, the processors 804 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 812 and a processor 814 that execute the instructions 802. The term “processor” is intended to include multi-core processors that may comprise two or more independent processors (sometimes referred to as “cores”) that may execute instructions contemporaneously. Although FIG. 8 shows multiple processors 804, the machine 800 may include a single processor with a single-core, a single processor with multiple cores (e.g., a multi-core processor), multiple processors with a single core, multiple processors with multiples cores, or any combination thereof.

The memory 806 includes a main memory 816, a static memory 818, and a storage unit 820, both accessible to the processors 804 via the bus 810. The main memory 806, the static memory 818, and storage unit 820 store the instructions 802 embodying any one or more of the methodologies or functions described herein. The instructions 802 may also reside, completely or partially, within the main memory 816, within the static memory 818, within machine-readable medium 822 within the storage unit 820, within at least one of the processors 804 (e.g., within the processor's cache memory), or any suitable combination thereof, during execution thereof by the machine 800.

The I/O components 808 may include a wide variety of components to receive input, provide output, produce output, transmit information, exchange information, capture measurements, and so on. The specific I/O components 808 that are included in a particular machine will depend on the type of machine. For example, portable machines such as mobile phones may include a touch input device or other such input mechanisms, while a headless server machine will likely not include such a touch input device. It will be appreciated that the I/O components 808 may include many other components that are not shown in FIG. 8. In various examples, the I/O components 808 may include user output components 824 and user input components 826. The user output components 824 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 826 may include alphanumeric input components (e.g., a keyboard, a touch screen configured to receive alphanumeric input, video input (e.g., camera), peer-to-peer input (e.g., chatbot), a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 808 may include biometric components 828, motion components 830, environmental components 832, or position components 834, among a wide array of other components. The motion components 830 include acceleration sensor components (e.g., accelerometer), gravitation sensor components, rotation sensor components (e.g., gyroscope).

The environmental components 832 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

The position components 834 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 808 further include communication components 836 operable to couple the machine 800 to a network 838 or devices 840 via respective coupling or connections. For example, the communication components 836 may include a network interface component or another suitable device to interface with the network 838. In further examples, the communication components 836 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 840 may be another machine or any of a wide variety of peripheral devices (e.g., a peripheral device coupled via a USB).

Moreover, the communication components 836 may detect identifiers or include components operable to detect identifiers. For example, the communication components 836 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 836, such as location via Internet Protocol (IP) geolocation, location via Wi-Fi® signal triangulation, location via detecting an NFC beacon signal that may indicate a particular location, and so forth.

The various memories (e.g., main memory 816, static memory 818, and memory of the processors 804) and storage unit 820 may store one or more sets of instructions and data structures (e.g., software) embodying or used by any one or more of the methodologies or functions described herein. These instructions (e.g., the instructions 802), when executed by processors 804, cause various operations to implement the disclosed examples.

The instructions 802 may be transmitted or received over the network 838, using a transmission medium, via a network interface device (e.g., a network interface component included in the communication components 836) and using any one of several well-known transfer protocols (e.g., hypertext transfer protocol (HTTP)). Similarly, the instructions 802 may be transmitted or received using a transmission medium via a coupling (e.g., a peer-to-peer coupling) to the devices 840.

### Software Architecture

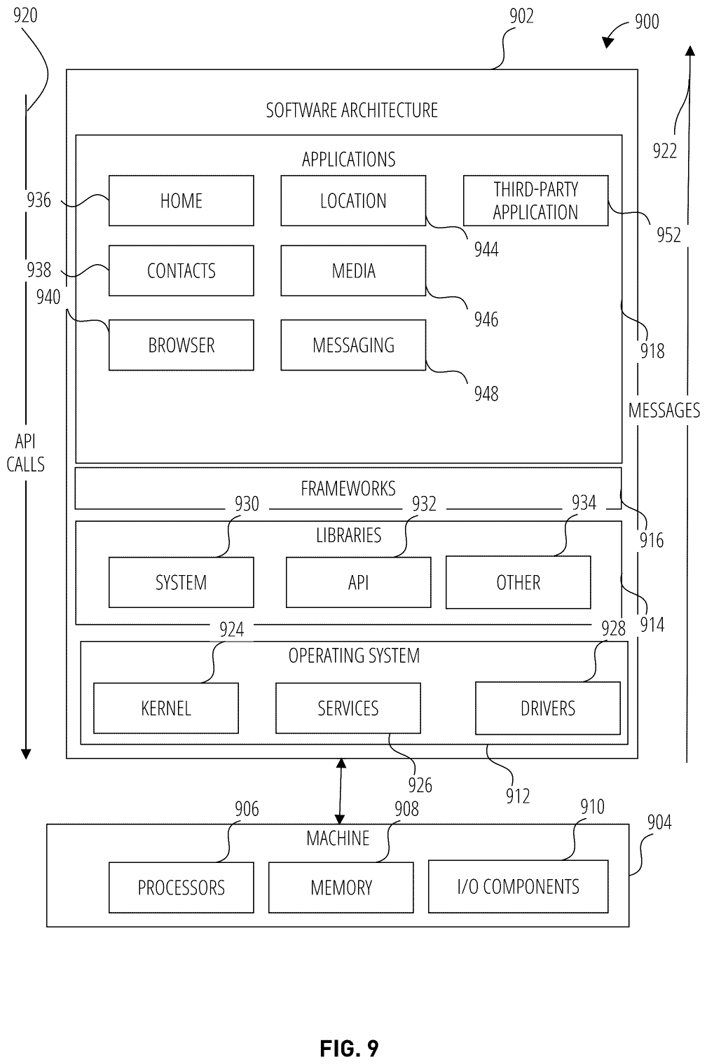

FIG. 9 is a block diagram 900 illustrating a software architecture 902, which can be installed on any one or more of the devices described herein. The software architecture 902 is supported by hardware such as a machine 904 that includes processors 906, memory 908, and I/O components 910. In this example, the software architecture 902 can be conceptualized as a stack of layers, where each layer provides a particular functionality. The software architecture 902 includes layers such as an operating system 912, libraries 914, frameworks 916, and applications 918. Operationally, the applications 918 invoke API calls 920 through the software stack and receive messages 922 in response to the API calls 920.

The operating system 912 manages hardware resources and provides common services. The operating system 912 includes, for example, a kernel 924, services 926, and drivers 928. The kernel 924 acts as an abstraction layer between the hardware and the other software layers. For example, the kernel 924 provides memory management, processor management (e.g., scheduling), component management, networking, and security settings, among other functionalities. The services 926 can provide other common services for the other software layers. The drivers 928 are responsible for controlling or interfacing with the underlying hardware. For instance, the drivers 928 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 914 provide a common low-level infrastructure used by the applications 918. The libraries 914 can include system libraries 930 (e.g., C standard library) that provide functions such as memory allocation functions, string manipulation functions, mathematic functions, and the like. In addition, the libraries 914 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 914 can also include a wide variety of other libraries 934 to provide many other APIs to the applications 918.

The frameworks 916 provide a common high-level infrastructure that is used by the applications 918. For example, the frameworks 916 provide various graphical user interface (GUI) functions, high-level resource management, and high-level location services. The frameworks 916 can provide a broad spectrum of other APIs that can be used by the applications 918, some of which may be specific to a particular operating system or platform.

In an example, the applications 918 may include a home application 936, a contacts application 938, a browser application 940, a location application 944, a media application 946, a messaging application 948, and a broad assortment of other applications such as a third-party application 952. The applications 918 are programs that execute functions defined in the programs. Various programming languages can be employed to create one or more of the applications 918, structured in a variety of manners, such as object-oriented programming languages (e.g., Objective-C, Java, or C++) or procedural programming languages (e.g., C or assembly language). In a specific example, the third-party application 952 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 952 can invoke the API calls 920 provided by the operating system 912 to facilitate functionalities described herein.

### Machine-Learning Pipeline

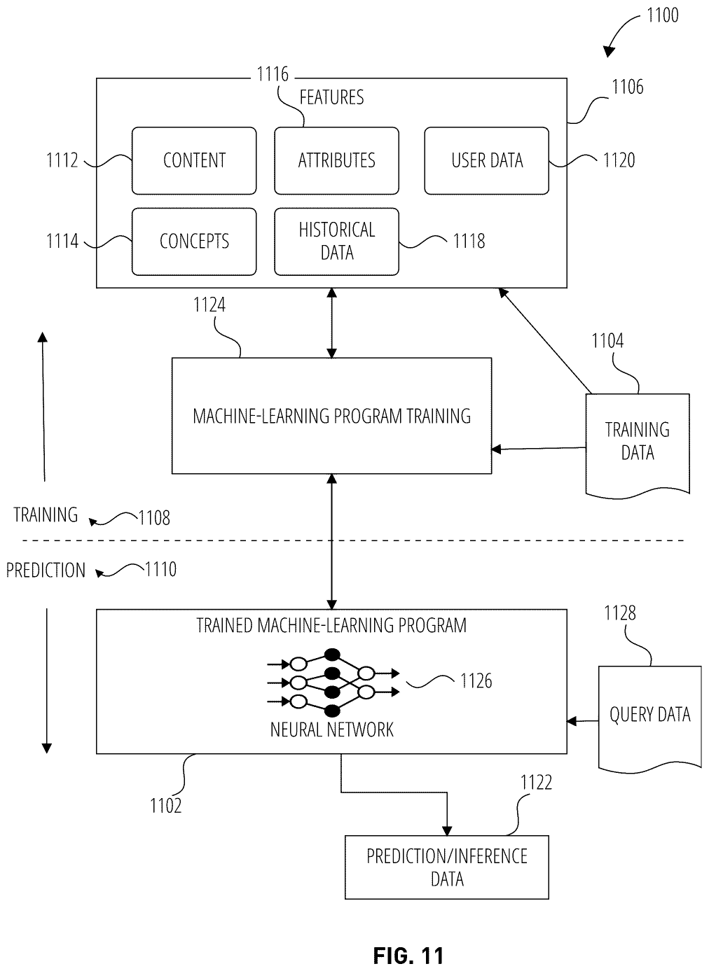

FIG. 11 is a flowchart depicting a machine-learning pipeline 1100, according to some examples. The machine-learning pipelines 1100 may be used to generate a trained model, for example the trained machine-learning program 1102 of FIG. 11, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

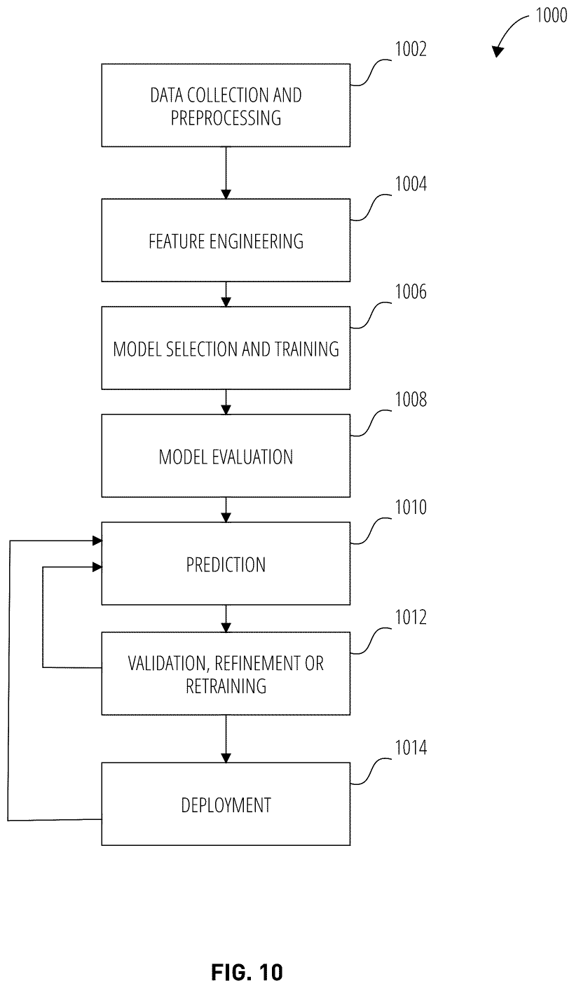

Generating a trained machine-learning program 1102 may include multiple types of phases that form part of the machine-learning pipeline 1100, including for example the following phases 1000 illustrated in FIG. 10:
Data collection and preprocessing 1002: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 1004: This may include selecting and transforming the training data 1104 to create features that are useful for predicting the target variable. Feature engineering may include (1) receiving features 1106 (e.g., as structured or labeled data in supervised learning) and/or (2) identifying features 1106 (e.g., unstructured or unlabeled data for unsupervised learning) in training data 1104.
Model selection and training 1006: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 1008: This may include evaluating the performance of a trained model (e.g., the trained machine-learning program 1102) on a separate testing dataset. This can help determine if the model is overfitting or underfitting and if it is suitable for deployment.
Prediction 1010: This involves using a trained model (e.g., trained machine-learning program 1102) to generate predictions on new, unseen data.
Validation, refinement or retraining 1012: This may include updating a model based on feedback generated from the prediction phase, such as new data or user feedback.
Deployment 1014: This may include integrating the trained model (e.g., the trained machine-learning program 1102) into a larger system or application, such as a web service, mobile app, or IoT device. This can involve setting up APIs, building a user interface, and ensuring that the model is scalable and can handle large volumes of data.

FIG. 11 illustrates two example phases, namely a training phase 1108 (part of the model selection and trainings 1006) and a prediction phase 1110 (part of prediction 1010). Prior to the training phase 1108, feature engineering 1004 is used to identify features 1106. This may include identifying informative, discriminating, and independent features for the effective operation of the trained machine-learning program 1102 in pattern recognition, classification, and regression. In some examples, the training data 1104 includes labeled data, which is known data for pre-identified features 1106 and one or more outcomes.

Each of the features 1106 may be a variable or attribute, such as individual measurable property of a process, article, system, or phenomenon represented by a data set (e.g., the training data 1104). Features 1106 may also be of different types, such as numeric features, strings, vectors, matrices, encodings, and graphs, and may include one or more of content 1112, concepts 1114, attributes 1116, historical data 1118 and/or user data 1120, merely for example. Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 1108, the machine-learning pipeline 1100 uses the training data 1104 to find correlations among the features 1106 that affect a predicted outcome or prediction/inference data 1122.

With the training data 1104 and the identified features 1106, the trained machine-learning program 1102 is trained during the training phase 1108 during machine-learning program training 1124. The machine-learning program training 1124 appraises values of the features 1106 as they correlate to the training data 1104. The result of the training is the trained machine-learning program 1102 (e.g., a trained or learned model).

Further, the training phase 1108 may involve machine learning, in which the training data 1104 is structured (e.g., labeled during preprocessing operations), and the trained machine-learning program 1102 implements a relatively simple neural network 1126 capable of performing, for example, classification and clustering operations. In other examples, the training phase 1108 may involve deep learning, in which the training data 1104 is unstructured, and the trained machine-learning program 1102 implements a deep neural network 1126 that is able to perform both feature extraction and classification/clustering operations.

A neural network 1126 may, in some examples, be generated during the training phase 1108, and implemented within the trained machine-learning program 1102. The neural network 1126 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 1126 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 1126 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1108, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 1126 is iteratively trained by adjusting model parameters to minimize a specific loss function or maximize a certain objective. The system can continue to train the neural network 1126 by adjusting parameters based on the output of the validation, refinement, or retraining block 1012, and rerun the prediction 1010 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 1126 even after deployment 1014 of the neural network 1126. The neural network 1126 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 1110, the trained machine-learning program 1102 uses the features 1106 for analyzing query data 1128 to generate inferences, outcomes, or predictions, as examples of a prediction/inference data 1122. For example, during prediction phase 1110, the trained machine-learning program 1102 is used to generate an output. Query data 1128 is provided as an input to the trained machine-learning program 1102, and the trained machine-learning program 1102 generates the prediction/inference data 1122 as output, responsive to receipt of the query data 1128. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 1102 may be a generative AI model. Generative AI is a term that may refer to any type of artificial intelligence that can create new content from training data 1104. For example, generative AI can produce text, images, video, audio, code or synthetic data that are similar to the original data but not identical.

Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 1122 that is output include trend assessment and predictions, translations, summaries, image or video recognition and categorization, natural language processing, face recognition, user sentiment assessments, advertisement targeting and optimization, voice recognition, or media content generation, recommendation, and personalization.

### Usage Cases for Tokenization, Ownership, Use, and/or the Like

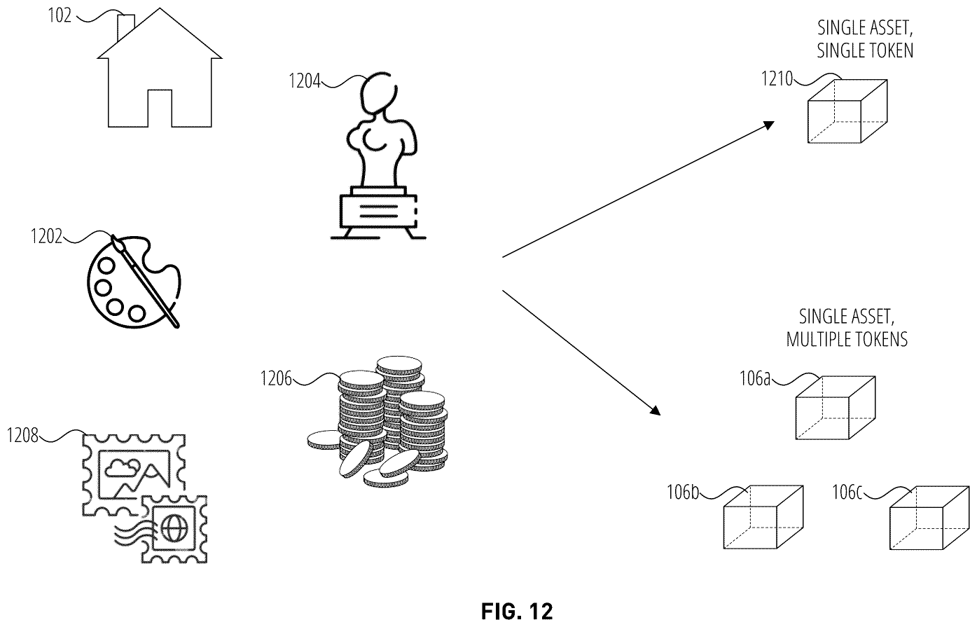

FIG. 12 illustrates tokenization of an asset as a whole, according to some examples. In some cases, a real world asset is not divided into parts by the tokenization system. For example, a home 102 is tokenized as a whole and not divided into different rooms. In some cases, the tokenization system tokenizes assets that are not easily dividable without changing the asset itself, such as a sculpture 1204, a painting 1202, a stamp in a stamp collection 1208, a coin in a rare coin collection 1206, and/or the like.

In some cases, the tokenization system generates and/or mints a single token 1210 corresponding to ownership or usage rights for the individual asset. In other cases, the tokenization system generates and/or mints multiple tokens 106a, 106b, 106c representing fractional ownership and/or different usage rights for the individual asset.

As users gain ownership and/or usage rights for the individual asset, users can start utilizing the asset as per the agreement and/or contractual terms (as further described herein).

In some cases, asset owners can jointly tokenize assets. For example, the artist and sculptor can jointly tokenize their paintings and sculptures. The joint assets can be tokenized either into a single token or multiple tokens. In some cases, the individual assets are valuated and tokens are assigned respectively. In other cases, a single token provides ownership and/or usage of the joint assets.

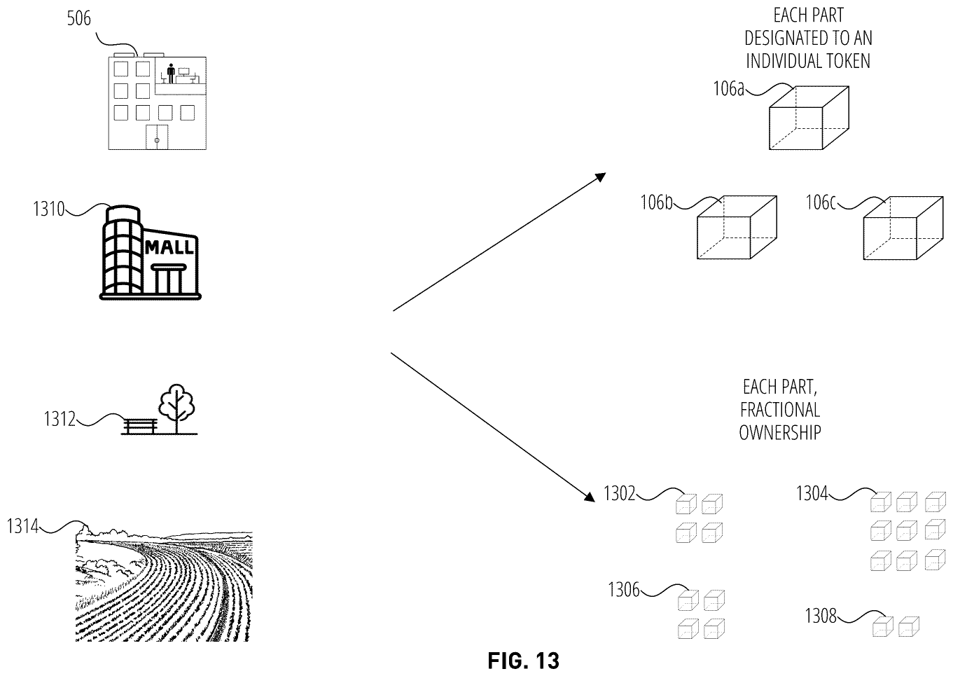

FIG. 13 illustrates tokenization of an asset that is divisible into parts, according to some examples. The tokenization system can divide an asset, such as a building 506, a mall 1310, a park 1312, farmland 1314, into parts and tokenize individual parts for use and/or ownership. For example, a building can be divided into apartments, a mall can be divided into sections for stores, farmland divided into parcels, and/or the like.

In some cases, the tokenization system generates an individual usage and/or ownership token for each divisible part, such as token 106a for a first apartment unit, token 106b for a second apartment unit, and 106c for a third apartment unit. In other cases, the tokenization system generates multiple tokens for each part. such as tokens 1302 for a first store front, tokens 1304 for a second store front, tokens 1306 for a third store front, 1308, for a fourth store front and/or the like. In some cases, the amount of tokens for each part is determined using the valuation methods and processes as further described herein.

In some cases, the tokenization system identifies divisible parts based on third party data, such as data on the number of units in an apartment building retrieved from a real estate or government website. In some cases, the tokenization system applies a machine learning model that is trained to automatically determine divisible portions of a particular asset. For example, the machine learning model can receive as input an address of an asset, a type of asset (such as if the asset type indicates a divisible number of parts such as a duplex), input from the asset owner of characteristics of the asset, and/or the like (other inputs to the machine learning model further described herein).

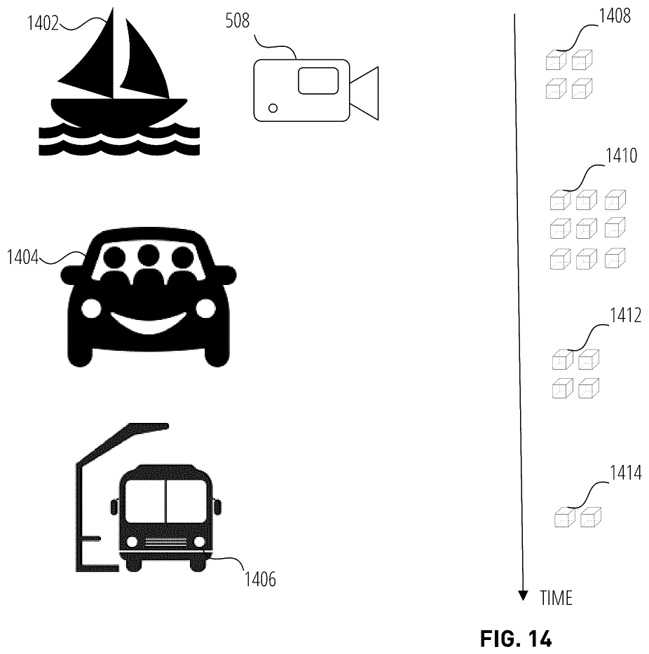

FIG. 14 illustrates tokenizing ownership and/or usage across time, according to some examples. In some cases, the tokenization system can tokenize an asset, such as a boat 1402, equipment 508, car 1404, public transportation 1406, and/or the like over time. The tokenization system applies ownership and/or usage rights over time. For example, a boat 1404 can be rented throughout the year for the use in boat tours.

The tokenization system can generate tokens according to the time and/or time frame desired for ownership and/or usage. For example, the tokenization system determines that boat tours are in demand in certain parts of the year but not in others. The tokenization system can apply the valuation methods and processes as further described herein to value the ownership and/or usage for particular time periods. For example, the time frame for tokens 1410 are in high demand, and thus more tokens are required for ownership and/or usage for these time slots, whereas the time periods for tokens 1408, 1412, and 1414 are in less demand and thus less tokens are minted for these time periods.

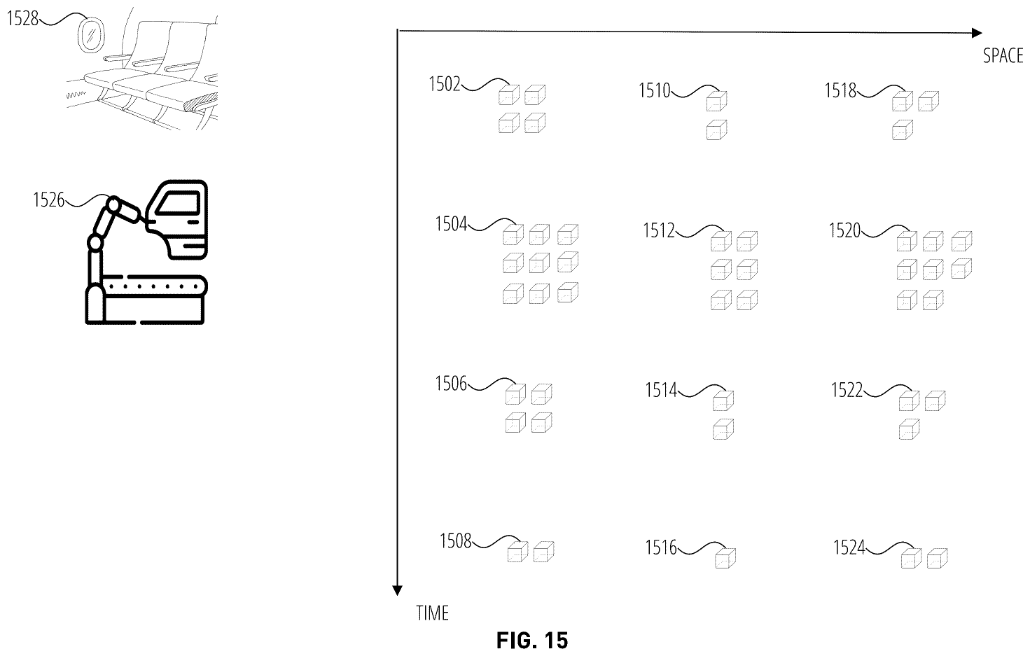

FIG. 15 illustrate tokenizing ownership and/or usage across time and parts, according to some examples. In some cases, the tokenization system tokenizes an asset across time and space. For example, the tokenization system divides an airplane 1528 into multiple seats or a multiple factory production lines in a factory 1526.

An airplane can have tens or hundreds of seats, each of which could be tokenized. In some cases, a group of seats can be tokenized, such as 4 seats for a family of 4. Such tokens can be tied to a particular airplane or to an airline with a fleet of airplanes.

In some cases, the tokenization system tokenizes ownership and/or usage across multiple factors, such as time and parts. It is appreciated that the tokenization system can tokenize an asset across one or more other factors, such as time and location, time parts and location, and/or the like.

As noted herein, the tokenization system can determine a valuation for the token based on these factors. In FIG. 15, the tokenization system determines that the certain seats at a particular time frame corresponding to tokens 1504 and 1520 are the highest in demand or highest in cost. As such, the more tokens are minted for the seats and time corresponding to tokens 1504 and 1520 than that for tokens 1502, 1510, 1518, 1512, 1506, 1514, 1522, 1508, 1516, and 1524.

In some cases, a factory with multiple production lines can tokenize each production line over different periods of time. Ownership of Tokens allow for the usage of associated production lines and collection of proceeds from the product line output. In some cases, a livestock production facility can tokenize each production line and across multiple cycles within a calendar year and offer those tokens to individual operators. These operators can make use of the facility for their own production and/or further offer the production line to other operators who could make use of the facility.

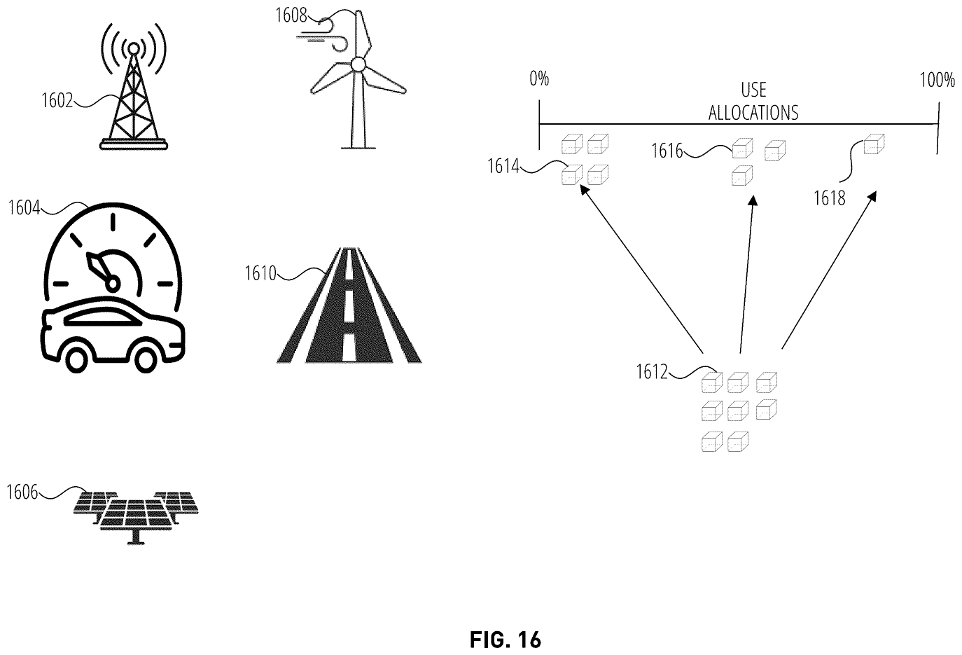

FIG. 16 illustrates tokenization for use allocations, according to some examples. The tokenization system can tokenize use allocations for assets. The tokenization system can tokenize cellphone towers 1602 such as based on data bandwidth usage. The tokenization system can tokenize amount of electricity generation by a wind turbine 1608 or solar farms 1606. The tokenization system can tokenize automobiles 1604 based on mileage. The tokenization system can tokenize use of roads 1610, such as an amount of traffic or length of travel.

Use allocations can be uniform across use, such as allocating the same amount of tokens for use of an automobile from 0-10 miles, 10-20 miles, 20-30 miles, etc. As shown in FIG. 16, use allocations can be different across use allocations. The automobile can be equivalent to a total token group 1612. However the use of the automobile may be of a higher value when the automobile is new. As such, the first group of miles for the automobile may be worth more tokens, such as tokens 1614, than when the automobile is at the middle of its lifespan, such as tokens 1616, or the end of its lifespan, such as token 1618.

In some cases, the tokenization system tokenizes cellphone towers (e.g., data use), automobile or farm equipment (e.g., mileage), oil wells, solar farms, wind turbines, other energy sources, mining rights, water rights, fishing quotas, bridges, toll roads, public transport, locations with services (e.g., fitness center, copy center, restaurant), and/or the like.

The tokenization system can tokenize an internet provider based on a provided bandwidth. The tokenization system can generate tokens representative of portions of bandwidth usage and provide such tokens to a large user base or virtual providers. The owners of these tokens can then use the associated bandwidth or sell the bandwidth to other users. A geographically diverse shared electricity grid can also tokenize its production of electricity and offer tokens to individual electricity producers that best meet the demands of their customers. Both these examples demonstrate the ability of the tokenization system to improve utilization of temporal assets that would be lost if not used immediately.

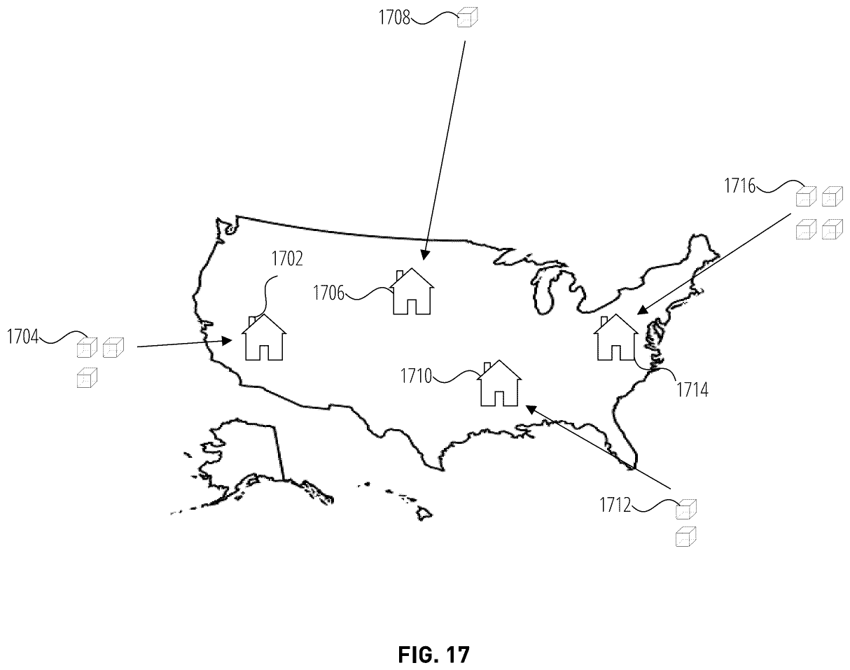

FIG. 17 illustrates token generation based on location, according to some examples. In some cases, the tokenization system tokenizes homes 1702, 1706, 1710, and 1714. Depending on the location of the home, the home may be valued differently. The tokenization system takes into consideration location, and/or other characteristics as described further herein in the valuation model, to determine a number of tokens to generate for the home. For example, home 1702 is provided with 3 tokens 1704, home 1706 is provided with 1 token 1708, home 1710 is provided with 2 tokens 1712, and home 1714 is provided with 4 tokens 1716.

In some cases, the tokenization system tokenizes medical facilities, clinics, wellness centers, companies (legal practices, accounting firms, consulting firms, research centers, etc.), and/or the like based on at least location.

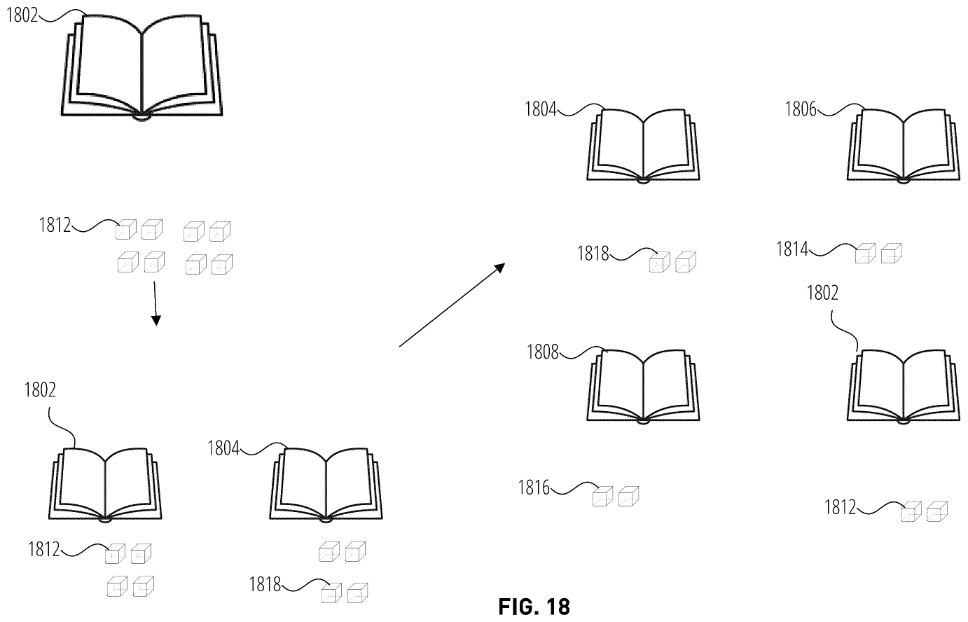

FIG. 18 illustrates token generation for copies of goods, according to some examples. In some cases, the tokenization system tokenizes copies of goods, such as artwork, creative works, books, movies, designs, architectural plans, educational content, music, software, formulas, recipes, advertisements, intellectual property, machine learning models, virtual objects (objects in virtual reality, augmented reality, mixed reality, etc.), in-game items, in-application items, pharmaceuticals, and/or the like.

In some cases, as more copies are made, the more tokens are generated and/or the reduction of value for each token. For example, a book 1802 without any copies can be equivalent to 8 tokens 1812. The tokenization system can generate a first copy 1804 of the book and with the generated first copy, divide the number of tokens (e.g., 1812 and 1814) equally between the original book 1802 and the first copy 1804. As such, the owner can decide how many copies to generate and how granular the owner desires the tokens and asset to be sold. In the next step, second copy 1806 and third copy 1808 are generated, and the tokenization system generates tokens 1818 and 1816 respectively. As shown in FIG. 18, after there are 4 copies in existence, the value for each book is reduced from 8 tokens down to 2 tokens each.

Although particular examples are described herein, such as a home being non-divisible and tokenized, it is appreciated that the example assets described herein can be applied to other types of tokenization. For example, the home 102 can be tokenized for usage across time, such as a short term rental.

The previous use cases can be combined whereby different features can be obtained from each case. This allows for a large amount of flexibility according to the underlying assets and intended usage. For example, the tokenization system can use the same tokens for different assets enabling flexibility in exchange of assets. For example, the tokenization system can apply tokens from a token owner issued by the same asset owner for use of different assets even if the assets are different or have different usage models.

Assets can be owned by a single or multiple asset owners. An asset owner can have a single or multiple assets. Assets can be used by a single or multiple tenants simultaneously. Asset usage can span a single or multiple time periods. A tenant may be allowed to utilize the asset for themselves only or offer it to be utilized by others. Intermediaries can borrow Tokens and acquire some asset ownership rights to offer the assets to other tenants. Asset utilization returns are shared with all token owners and potentially a portion of tenant returns. The asset itself can be made eligible for ownership if enough tokens are owned by a tenant.

As further described herein, the ownership and/or usage can be on a first come first serve basis, the tokenization system can implement a bidding auction whereby users can bid tokens and/or payments for a certain ownership or usage of an asset, and/or the like.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: receiving a digitized asset rights document for a real world asset from an asset holder; identifying a value of the real world asset; generating a plurality of digital tokens corresponding to the value of the real world asset based on the value and a value for each digital token, each digital token representing a fractional ownership interest in the real world asset; transmitting the generated digital tokens to a digital wallet associated with the asset holder; periodically, during an asset utilization period for an asset utilizer: receiving an indication of an asset transaction from the asset utilizer utilizing the real world asset; identifying a first portion of the asset transaction transmitted to the asset holder; determining a number of digital tokens corresponding to a second portion of the asset transaction based on the first portion; and transferring the number of digital tokens corresponding to the second portion from the digital wallet of the asset holder to a digital wallet of the asset utilizer; determining that a quantity of digital tokens within the digital wallet of the asset utilizer equals or exceeds the number of digital tokens corresponding to the value of the real world asset; and transferring the digitized asset rights document for the real world asset to the asset utilizer, the transferring indicating full ownership of the real world asset by the asset utilizer.

In Example 2, the subject matter of Example 1 includes, wherein the operations further comprise: in response to transferring the digitized asset rights document for the real world asset to the asset utilizer, purging the tokens corresponding to the real world asset from a circulating supply of tokens.

In Example 3, the subject matter of Examples 1-2 includes, wherein generating the plurality of digital tokens comprises initiating generation of the plurality of digital tokens by a group of nodes of a blockchain, wherein the operations further comprise: initiating recordation of the generation of the plurality of digital tokens onto a distributed ledger of the blockchain.

In Example 4, the subject matter of Example 3 includes, wherein transferring the digitized asset rights document comprises initiating the recordation of the ownership of the digitized assets rights document to the asset utilizer onto the distributed ledger.

In Example 5, the subject matter of Examples 1-4 includes, wherein the operations further comprise: in response to a lapse of the asset utilization period for the asset utilizer, determine whether the quantity of digital tokens within the digital wallet of the asset utilizer equals or exceeds the number of digital tokens corresponding to the value of the real world asset; and in response to determining that the quantity of digital tokens within the digital wallet of the asset utilizer does not equal or exceed the number of digital tokens corresponding to the value of the real world asset, renew the asset utilization period.

In Example 6, the subject matter of Examples 1-5 includes, wherein the operations further comprise: determining a number of the plurality of digital tokens corresponding to the value of the real world asset based on a ratio of the value of the real world asset with the value for each digital token.

In Example 7, the subject matter of Examples 1-6 includes, wherein the real world asset includes a real estate property, the digitized asset rights documents including a digitized deed, and the asset holder including a real estate property owner.

In Example 8, the subject matter of Example 7 includes, wherein the asset utilization period is for a lease agreement, the asset utilizer including a tenant.

In Example 9, the subject matter of Examples 1-8 includes, wherein the operations further comprise: performing optical character recognition (OCR) on the digitized asset ownership document, and converting data identified from performing the OCR into a standardized format, identifying the value of the real world asset being based on the converted data.

In Example 10, the subject matter of Examples 1-9 includes, wherein the operations further comprise: identifying a third portion of the asset transaction transmitted to a user other than the asset utilizer, the second portion being based on the first and third portion.

In Example 11, the subject matter of Examples 1-10 includes, wherein determining the number of digital tokens corresponding to the second portion comprises dividing the second portion by the value of each digital token.

In Example 12, the subject matter of Examples 1-11 includes, wherein the operations further comprise: providing the asset utilizer with access to the real world asset.

In Example 13, the subject matter of Example 12 includes, wherein providing the asset utilizer with access to the real world asset comprises generating a unique access code for a digital lock or security system of the real world asset.

In Example 14, the subject matter of Examples 12-13 includes, wherein providing the asset utilizer with access to the real world asset comprises transmitting a signal to one or more Internet of Things (IoT) devices associated with the real world asset such that the one or more IoT devices grants access to the asset utilizer.

In Example 15, the subject matter of Examples 12-14 includes, wherein providing the asset utilizer with access to the real world asset comprises automatically booking the real world asset for the asset utilizer for the asset utilization period.

In Example 16, the subject matter of Examples 1-15 includes, wherein the asset utilizer does not have the ability to initiate or accept an ownership transaction that transfers one or more tokens from an asset utilizer digital wallet to another digital wallet during the asset utilization period.

In Example 17, the subject matter of Examples 1-16 includes, wherein the operations further comprise: initiating or accepting, by the asset utilizer, an ownership transaction that transfers one or more tokens from an asset utilizer digital wallet to another digital wallet during the asset utilization period.

In Example 18, the subject matter of Examples 1-17 includes, wherein the real world asset includes a collection of real world assets, wherein the asset utilizer is able to use one of the real world assets, wherein the tokens represent fractional ownership for the collection of the real world assets, wherein the value of the tokens required for the transfer of ownership is the value of the collection of the real world assets.

In Example 19, the subject matter of Examples 1-18 includes, wherein the operations further comprise: receiving a first digital signature from the asset utilizer and a second digital signature from the asset holder prior to transferring the digitized asset rights document for the real world asset to the asset utilizer.

Example 20 is a method comprising: receiving a digitized asset rights document for a real world asset from an asset holder; identifying a value of the real world asset; generating a plurality of digital tokens corresponding to the value of the real world asset based on the value and a value for each digital token, each digital token representing a fractional ownership interest in the real world asset; transmitting the generated digital tokens to a digital wallet associated with the asset holder; periodically, during an asset utilization period for an asset utilizer: receiving an indication of an asset transaction from the asset utilizer utilizing the real world asset; identifying a first portion of the asset transaction transmitted to the asset holder; determining a number of digital tokens corresponding to a second portion of the asset transaction based on the first portion; and transferring the number of digital tokens corresponding to the second portion from the digital wallet of the asset holder to a digital wallet of the asset utilizer; determining that a quantity of digital tokens within the digital wallet of the asset utilizer equals or exceeds the number of digital tokens corresponding to the value of the real world asset; and transferring the digitized asset rights document for the real world asset to the asset utilizer, the transferring indicating full ownership of the real world asset by the asset utilizer.

Example 21 is a non-transitory computer-readable storage medium storing instructions that, when executed by at least one processor, cause the at least one processor to perform operations comprising: receiving a digitized asset rights document for a real world asset from an asset holder; identifying a value of the real world asset; generating a plurality of digital tokens corresponding to the value of the real world asset based on the value and a value for each digital token, each digital token representing a fractional ownership interest in the real world asset; transmitting the generated digital tokens to a digital wallet associated with the asset holder; periodically, during an asset utilization period for an asset utilizer: receiving an indication of an asset transaction from the asset utilizer utilizing the real world asset; identifying a first portion of the asset transaction transmitted to the asset holder; determining a number of digital tokens corresponding to a second portion of the asset transaction based on the first portion; and transferring the number of digital tokens corresponding to the second portion from the digital wallet of the asset holder to a digital wallet of the asset utilizer; determining that a quantity of digital tokens within the digital wallet of the asset utilizer equals or exceeds the number of digital tokens corresponding to the value of the real world asset; and transferring the digitized asset rights document for the real world asset to the asset utilizer, the transferring indicating full ownership of the real world asset by the asset utilizer.

Example 22 is at least one machine-readable medium including instructions that, when executed by processing circuitry, cause the processing circuitry to perform operations to implement any of Examples 1-21.

Example 23 is an apparatus comprising means to implement any of Examples 1-21.

Example 24 is a system to implement any of Examples 1-21.

Example 25 is a method to implement any of Examples 1-21.

Although examples described herein describe features of the tokenization system using a digitized asset rights document, it is appreciated that the features of the tokenization system can apply to other forms, such as real world property ownership certificate, digital physical property title, digitized asset rights, document, physical asset registry record, physical commodity ownership record document, real estate ownership certificate, real estate possession record, tangible asset ownership record, tangible property conveyance document, deed, title, and/or the like, and/or vice versa.

Although examples described herein describe features of the tokenization system using a real world asset, it is appreciated that the features of the tokenization system can apply to other forms, such as real world property, physical property, tangible property, physical commodity, real estate property, physical asset, real estate, tangible asset, real world asset, and/or the like, and/or vice versa.

Although examples described herein describe features of the tokenization system using an asset holder, it is appreciated that the features of the tokenization system can apply to other forms, such as real world property owner, physical property owner, tangible property owner, physical commodity holder, real estate property proprietor, physical asset possessor, real estate possessor, tangible asset custodian, and/or the like, and/or vice versa.

Although examples described herein describe features of the tokenization system using an asset utilizer, it is appreciated that the features of the tokenization system can apply to other forms, such as real world property user, physical property user, tangible property occupant, physical commodity occupier, real estate property utilizer, physical asset acquirer, real estate user, tangible asset renter, and/or the like, and/or vice versa.

Although examples described herein describe features of the tokenization system using a physical commodity acquirer, it is appreciated that the features of the tokenization system can apply to other forms, such as real estate recipient, tangible asset procurer, and/or the like, and/or vice versa.

Although examples described herein describe features of the tokenization system using a digital tokens, it is appreciated that the features of the tokenization system can apply to other forms, such as digital rights tokens, virtual asset units, electronic ownership tokens, fractionalized property token, digital real estate property token, physical asset digital ledger coins, asset-backed tokens, and/or the like, and/or vice versa.

Although examples described herein describe features of the tokenization system using a digital wallet, it is appreciated that the features of the tokenization system can apply to other forms, such as digital rights token storage, virtual asset storage, electronic token data repository, tokenized account, digital Token repository, digital ledger wallet, digital token storage, virtual token storage, and/or the like, and/or vice versa.

Although examples described herein describe features of the tokenization system using an asset transaction, it is appreciated that the features of the tokenization system can apply to other forms, such as remittance, virtual asset relocation, tokenized exchange, token resource allocation, token provision, digital ledger coin transfer, digital token relocation, token disbursement, asset transaction, digital token relocation, and/or the like, and/or vice versa. Moreover, the tokens in the token disbursement, relocation, remittance, exchange, provisions and/or the like described herein can be different tokens than the tokens that represent usage rights or ownership rights.

Although examples described herein describe features of the tokenization system using an asset utilization period, it is appreciated that the features of the tokenization system can apply to other forms, such as real world property use term, physical property utilization period, occupancy span, tokenized tenure, physical asset use duration, real estate utilization period, and/or the like, and/or vice versa.

### CONCLUSION

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
receiving a digitized asset rights document for a real world asset from an asset holder;
identifying a value of the real world asset;
generating a plurality of digital tokens corresponding to the value of the real world asset based on the value and a value for each digital token, each digital token representing a fractional ownership interest in the real world asset;
transmitting the generated digital tokens to a digital wallet associated with the asset holder;
periodically, during an asset utilization period for an asset utilizer:
receiving an indication of an asset transaction from the asset utilizer utilizing the real world asset;
identifying a first portion of the asset transaction transmitted to the asset holder;
determining a number of digital tokens corresponding to a second portion of the asset transaction based on the first portion; and
transferring the number of digital tokens corresponding to the second portion from the digital wallet of the asset holder to a digital wallet of the asset utilizer;
determining that a quantity of digital tokens within the digital wallet of the asset utilizer equals or exceeds the number of digital tokens corresponding to the value of the real world asset; and
transferring the digitized asset rights document for the real world asset to the asset utilizer, the transferring indicating full ownership of the real world asset by the asset utilizer.

2. The system of claim 1, wherein the operations further comprise: in response to transferring the digitized asset rights document for the real world asset to the asset utilizer, purging the tokens corresponding to the real world asset from a circulating supply of tokens.

3. The system of claim 1, wherein generating the plurality of digital tokens comprises initiating generation of the plurality of digital tokens by a group of nodes of a blockchain, wherein the operations further comprise: initiating recordation of the generation of the plurality of digital tokens onto a distributed ledger of the blockchain.

4. The system of claim 3, wherein transferring the digitized asset rights document comprises initiating the recordation of the ownership of the digitized assets rights document to the asset utilizer onto the distributed ledger.

5. The system of claim 1, wherein the operations further comprise:
in response to a lapse of the asset utilization period for the asset utilizer, determine whether the quantity of digital tokens within the digital wallet of the asset utilizer equals or exceeds the number of digital tokens corresponding to the value of the real world asset; and
in response to determining that the quantity of digital tokens within the digital wallet of the asset utilizer does not equal or exceed the number of digital tokens corresponding to the value of the real world asset, renew the asset utilization period.

6. The system of claim 1, wherein the operations further comprise: determining a number of the plurality of digital tokens corresponding to the value of the real world asset based on a ratio of the value of the real world asset with the value for each digital token.

7. The system of claim 1, wherein the real world asset includes a real estate property, the digitized asset rights documents including a digitized deed, and the asset holder including a real estate property owner.

8. The system of claim 7, wherein the asset utilization period is for a lease agreement, the asset utilizer including a tenant.

9. The system of claim 1, wherein the operations further comprise: performing optical character recognition (OCR) on the digitized asset ownership document, and converting data identified from performing the OCR into a standardized format, identifying the value of the real world asset being based on the converted data.

10. The system of claim 1, wherein the operations further comprise: identifying a third portion of the asset transaction transmitted to a user other than the asset utilizer, the second portion being based on the first and third portion.

11. The system of claim 1, wherein determining the number of digital tokens corresponding to the second portion comprises dividing the second portion by the value of each digital token.

12. The system of claim 1, wherein the operations further comprise: providing the asset utilizer with access to the real world asset.

13. The system of claim 12, wherein providing the asset utilizer with access to the real world asset comprises generating a unique access code for a digital lock or security system of the real world asset.

14. The system of claim 12, wherein providing the asset utilizer with access to the real world asset comprises transmitting a signal to one or more Internet of Things (IoT) devices associated with the real world asset such that the one or more IoT devices grants access to the asset utilizer.

15. The system of claim 12, wherein providing the asset utilizer with access to the real world asset comprises automatically booking the real world asset for the asset utilizer for the asset utilization period.

16. The system of claim 1, wherein the operations further comprise preventing the asset utilizer from initiating or accepting an ownership transaction that transfers one or more tokens from an asset utilizer digital wallet to another digital wallet during the asset utilization period.

17. The system of claim 1, wherein the operations further comprise: initiating or accepting, by the asset utilizer, an ownership transaction that transfers one or more tokens from an asset utilizer digital wallet to another digital wallet during the asset utilization period.

18. The system of claim 1, wherein the real world asset includes a collection of real world assets, wherein the asset utilizer is able to use one of the real world assets, wherein the tokens represent fractional ownership for the collection of the real world assets, wherein the value of the tokens required for the transfer of ownership is the value of the collection of the real world assets.

19. The system of claim 1, wherein the operations further comprise: receiving a first digital signature from the asset utilizer and a second digital signature from the asset holder prior to transferring the digitized asset rights document for the real world asset to the asset utilizer.

20. The system of claim 1, wherein the at least one processor is configured to apply the digitized asset rights document to a machine learning model, wherein the machine learning model is configured to perform the operations of identifying the value of the real world asset; generating the plurality of digital tokens corresponding to the value of the real world asset based on the value and the value for each digital token, each digital token representing the fractional ownership interest in the real world asset; and transmitting the generated digital tokens to the digital wallet associated with the asset holder.

21. The system of claim 1, wherein the at least one processor is configured to apply data corresponding to the asset transaction to a machine learning model, wherein the machine learning model is configured to perform the operations of identifying the first portion of the asset transaction transmitted to the asset holder; determining the number of digital tokens corresponding to the second portion of the asset transaction based on the first portion; and
transferring the number of digital tokens corresponding to the second portion from the digital wallet of the asset holder to the digital wallet of the asset utilizer.

22. The system of claim 1, wherein the at least one processor is configured to apply a machine learning model configured to perform the operations of determining that the quantity of digital tokens within the digital wallet of the asset utilizer equals or exceeds the number of digital tokens corresponding to the value of the real world asset; and transferring the digitized asset rights document for the real world asset to the asset utilizer, the transferring indicating full ownership of the real world asset by the asset utilizer.

23. A method comprising:
receiving a digitized asset rights document for a real world asset from an asset holder;
identifying a value of the real world asset;
generating a plurality of digital tokens corresponding to the value of the real world asset based on the value and a value for each digital token, each digital token representing a fractional ownership interest in the real world asset;
transmitting the generated digital tokens to a digital wallet associated with the asset holder;
periodically, during an asset utilization period for an asset utilizer:
receiving an indication of an asset transaction from the asset utilizer utilizing the real world asset;
identifying a first portion of the asset transaction transmitted to the asset holder;
determining a number of digital tokens corresponding to a second portion of the asset transaction based on the first portion; and
transferring the number of digital tokens corresponding to the second portion from the digital wallet of the asset holder to a digital wallet of the asset utilizer;
determining that a quantity of digital tokens within the digital wallet of the asset utilizer equals or exceeds the number of digital tokens corresponding to the value of the real world asset; and
transferring the digitized asset rights document for the real world asset to the asset utilizer, the transferring indicating full ownership of the real world asset by the asset utilizer.

24. A non-transitory computer-readable storage medium storing instructions that, when executed by at least one processor, cause the at least one processor to perform operations comprising:
receiving a digitized asset rights document for a real world asset from an asset holder;
identifying a value of the real world asset;
generating a plurality of digital tokens corresponding to the value of the real world asset based on the value and a value for each digital token, each digital token representing a fractional ownership interest in the real world asset;
transmitting the generated digital tokens to a digital wallet associated with the asset holder;
periodically, during an asset utilization period for an asset utilizer:
receiving an indication of an asset transaction from the asset utilizer utilizing the real world asset;
identifying a first portion of the asset transaction transmitted to the asset holder;
determining a number of digital tokens corresponding to a second portion of the asset transaction based on the first portion; and
transferring the number of digital tokens corresponding to the second portion from the digital wallet of the asset holder to a digital wallet of the asset utilizer;
determining that a quantity of digital tokens within the digital wallet of the asset utilizer equals or exceeds the number of digital tokens corresponding to the value of the real world asset; and
transferring the digitized asset rights document for the real world asset to the asset utilizer, the transferring indicating full ownership of the real world asset by the asset utilizer.
